(19) United States
(12) Patent Application Publication
(10) Pub. No.: US 2008/0140566 A1
(43) Pub. Date: Jun. 12, 2008

(54) METHOD AND SYSTEM FOR NETWORK GENERATING RANKED REFERRALS

(76) Inventor: DAVID W. CHOWINS, Prairie Village, KS (US)

Correspondence Address: Arthur Shaffer;Intellectual Property Center, Suite 100, 9233 Ward Parkway, Kansas City, MO, 64114, US

(21) Appl. No.: 11/953,042

(22) Filed: Dec. 8, 2007

Related U.S. Application Data
(60) Provisional application No. 60/869,256, filed on Dec. 8, 2006.

(51) Int. Cl. G06Q 30/00

(52) U.S. Cl. 705/39; 705/1

(57) ABSTRACT

A system and method for using a computer database system to provide a consumer with a recommended business provider listing which includes receiving consumer criteria with consumer preferences from a consumer and business provider criteria with business preferences and providing the consumer with one or more business listings where the business listings is in response to the consumer preferences and the consumer is responsive to the business preferences.

### CROSS REFERENCE TO RELATED APPLICATIONS

This application claims the priority benefit under 35 U.S.C. §119/120 based on application 60/869,256 filed Dec. 8, 2006.

### FIELD OF THE INVENTION

The present invention relates to a method and system for generating referrals within referral network and for promoting commercial transactions a database, a network and a computer and more specifically relates to a network for providing a consumer with a recommended business provider listing which matches a business provider, based upon associated business preferences, to the consumer providing one or more consumer preferences using the Internet, databases and servers.

### BACKGROUND OF THE INVENTION

While feedback ratings have become very well established in the internet auction community to gauge a seller's reputation, current approaches for rating non-auction businesses to no provide consumers with a comparable mechanism to gauge the reputation of businesses that consumers may use on a regular basis.

Presently businesses spend a considerable amount of money each year on marketing and advertising in an attempt to reach interested consumers. However, the breadth and effectiveness of existing approaches is often limited to paying for an expensive advertisement in a business or general directory in the hopes of reaching interested consumers. The drawback to this and other similar approaches is that overall; a business will often incur a considerable expense for each new customer obtained using the above mentioned methods.

Directories are frequently used sources for locating a business. Directories include both print and electronic listings of businesses in a variety of business categories. A drawback of using a directory is that the information may be of limited use to a consumer in search of a business provider. One reason for this is that bare listings provide an address and contact information. If only provided with the information from a bare directory listing, determining if the provider is a match requires the potentially interested consumer to contact individually listed providers to obtain additional information beyond the bare listing.

Even when an interested consumer is provided with information beyond that of a bare listing (in a provider placed advertisement) the amount of information provided by advertisements varies a great deal and may not provide enough information for the interested consumer to make an informed or semi-informed decision.

Unfortunately for consumers, yellow pages directories offer consumers little to no insights as to the reputation of the businesses listed therein. Therefore consumers are left to ascertain the quality of the business merely from the size of the advertisement and the representations of the businesses themselves.

For businesses, yellow pages ads are typically set at a fixed price per month or year not matter the results obtained can only be modified annually with each new issue, and even a modest ad can cost several thousand dollars per year. In general, the larger the ad, the better the results, but trial and error each year is often the only way a business can learn of the most cost effective ad size for their business. Many businesses view yellow pages ads as a necessary expense.

Another approach to locating a business involves the use of referral services. One drawback of referral services for consumers is that referral services may give a consumer the impression that a business recommended to the consumer by the services is reputable, when this may not be the case. However, the businesses in these referral services often have simply paid the referral service to be listed with little other significant criteria and virtually no feedback from the businesses' customers. Thus they are much like the yellow pages. In addition, referral services are often marketed in a limited fashion and may only provide referrals for a particular industry. So, prospects generally need to first locate an appropriate referral service in the particular industry which often may not even exist in the desired business category.

For businesses, a referral service, (if one exists in the particular industry) in addition to charging a monthly or annual fee to be listed with the service, often also charges a commission on the earnings from a particular prospect's business. This commission to the referral services is often difficult to account for since it is not always clear what amount to base the commission on, when the customer uses the business multiple times, or if the business extends the customer credit which is later not honored by the consumer. This is a particular concern when the referral service is operated by trade groups or other individuals in the industry which have an incentive to play favorites among their friends and associates within the industry.

Yet another approach to locating business involves use of a rating service. One drawback common to many referral service, is that existing methods of obtaining user feedback for the purpose of rating a business are often susceptible to skewed results due to extreme feedback ratings because a typical consumer may not be motivated to provide feedback about a business. On the other hand, consumers who have had very good or bad experiences with a business are likely to provide feedback. One reason for this is that many present systems provide little in the way of incentive for consumers to provide feedback unless the consumer has an agenda of some sort. As a consequence, the opinions of consumers with actual experience dealing with the business that does not fall into either extreme are often not reflected in business ratings. The general lack of incentives for consumers to provide business reviews tends to account for the fact that few businesses are reviewed on rating websites and of the businesses that are reviewed, relatively few have more than a handful of reviews. In some cases even these are completed by their own employees or the employees of their competitors. Thus, rating surveys are likely to be completed by those with an agenda of some sort, either to complain about a business or to praise a business. Accordingly it follows that the reliability of the few ratings that have been submitted may be in question.

It should also be noted that rating websites, such as Better Business Bureau, attempt to warn customers about particular problems customers have with certain businesses. Knowing whether or not a particular business should be avoided is useful information; however, such cautionary websites do not provide consumers with recommendations on which business to use.

Thus it is desirable for a rating system that provides consumer incentives for k on businesses. Additionally, it is desirable to provide a system for supplying referrals ness recommendations to consumers based on business reputation and other user criteria. Additionally, it is desirable for a system and method to increase business to interested consumers while maintaining or reducing marketing costs.

### SUMMARY OF THE INVENTION

The present invention provides a system and method for using a computer database system to provide a consumer with a recommended business provider listing including receiving consumer user criteria wherein said consumer criteria includes one or more user consumer preferences, receiving business provider criteria wherein said business provider criteria includes one or more provider preferences and providing said consumer user with one or more business provider listings wherein said business provider listing is responsive to said consumer preferences and said consumer user is responsive to said provider preferences.

Certain embodiments of the invention are outlined above in order that the detailed description thereof may be better understood, and in order that the present contributions to the art may be better appreciated. There are, of course, additional embodiments of the invention that will be described below and which will form the subject matter of the claims appended hereto.

In this respect, it is to be understood that the invention is not limited in its applications to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependence, each feature has merit when used independently.

### BRIEF DESCRIPTION OF THE DRAWINGS

FIG. 1 is a block diagram illustrating the relationship between a large network in accordance with one embodiment of the system and method of the present invention.

FIG. 2a is a flow chart illustrating the consumer search process performed in one embodiment of the present invention.

FIG. 2b is a flow chart illustrating the search criteria process performed in one embodiment of the present invention.

FIG. 3a illustrates an example of a membership selection screen generated in accordance with one embodiment of the present invention.

FIG. 3b is a flow chart illustrating a representative Consumer Login process preformed in accordance with one embodiment of the present invention.

FIG. 3c illustrates an example of a Consumer Sign Up screen generated in accordance with one embodiment of the present invention.

FIG. 3d is a flow chart illustrating a representative Business Login process preformed in accordance with one embodiment of the present invention.

FIG. 3e is a flow chart illustrating a Business Sign Up screen generated in accordance with one embodiment of the present invention.

FIG. 3f is a flow chart illustrating a representative Charity Login process preformed in accordance with one embodiment of the present invention.

FIG. 3g illustrates an example of a Charity Sign Up screen generated in accordance with one embodiment of the present invention.

FIG. 3h illustrates an example of a Other Nonprofit Sign Up screen generated in accordance with one embodiment of the present invention.

FIG. 4 illustrates one example of the Member Sign In screen generated in accordance with one embodiment of the present invention.

FIG. 5a is a flow chart illustrating a Member Profile process preformed in accordance with one embodiment of the present invention.

FIG. 5b illustrates one example of the Summary screen generated in accordance with one embodiment of the present invention.

FIG. 5c is a flow chart illustrating a Configure Private Network process performed in one embodiment of the present invention.

FIG. 5c is a flow chart illustrating an Account Setup Overview process preformed in accordance with one embodiment of the present invention.

FIG. 5d is a flow chart illustrating a Registered Consumer Search process preformed in accordance with one embodiment of the present invention.

FIG. 5e is a flow chart illustrating a Build Network process preformed in accordance with one embodiment of the present invention.

FIG. 5f is a flow chart illustrating a Join Network process preformed in accordance with one embodiment of the present invention.

FIGS. 5g-5i illustrate examples of the Business Search screens embodied in the present invention.

FIG. 5j illustrates one example of the View MyFriends screen generated in accordance with one embodiment of the present invention.

FIG. 6a illustrates one example of the Business Home Page screen generated in accordance with one embodiment of the present invention.

FIG. 6b illustrates one example of the Edit Business Profile screen generated in accordance with one embodiment of the present invention.

FIG. 6c illustrates one example of the Business Categories Search screen generated in accordance with one embodiment of the present invention.

FIG. 6d illustrates one example of the Additional Business Criteria screen generated in accordance with one embodiment of the present invention.

FIG. 6e illustrates one example of the Edit Additional Business Information screen generated in accordance with one embodiment of the present invention.

FIG. 6f is a illustrates one example of the Business Profile screen generated in accordance with one embodiment of the present invention.

FIG. 7a is a flow chart illustrating a Feedback process preformed in accordance with one embodiment of the present invention.

FIG. 7b illustrates one example of the Feedback Survey screen generated in accordance with one embodiment of the present invention.

FIG. 8a illustrates one example of the Charity Home Page screen generated in accordance with one embodiment of the present invention.

FIG. 8b illustrates one example of the Charity Overview screen generated in accordance with one embodiment of the present invention.

FIG. 8c illustrates one example of the Charity Configuration screen generated in accordance with one embodiment of the present invention.

FIG. 9a illustrates one example of the Referral Listing screen generated in accordance with one embodiment of the present invention.

FIG. 9b illustrates one example of the My Favorite Business screen generated in accordance with one embodiment of the present invention.

FIG. 9c illustrates one example of the Private Network Listing screen generated in accordance with one embodiment of the present invention.

FIG. 9d illustrates one example of the Joined Network screen generated in accordance with one embodiment of the present invention.

FIG. 9e illustrates one example of the Recently Viewed Businesses screen generated in accordance with one embodiment of the present invention.

FIG. 9f illustrates one example of the My Reviews screen generated in accordance with one embodiment of the present invention.

FIG. 9g illustrates one example of the Charity Network Members screen generated in accordance with one embodiment of the present invention.

### DETAILED DESCRIPTION

### 1. Introduction and Environment

As required, detailed embodiments of the present invention are disclosed herein; however, it is to be understood that the disclosed embodiments are merely exemplary of the invention, which may be embodied in various forms. The embodiments of the current invention shown in the attached drawings provide a system and method using a questionnaire and an advertisement within a referral network for generating proceeds from a business advertisement which may be divided between a referring member and a designated beneficiary based upon the scoring of the completed questionnaire by the system. In this way, the system provides a method to allow users of the system to share referrals with each other and to generate consistent, predictable system ranked referrals based upon the recorded historical transactions, associated business information and the selected search criteria. Optionally, the system may provide for the placement of prioritized advertisements within the referral system based upon the search criteria, associated business information and may optionally be enhanced based upon creating a competitive environment between similar situated businesses. Therefore, specific details disclosed herein are not to be interpreted as limiting, but merely as a basis for the claims and as a representative basis for teaching one skilled in the art to variously employ the present invention in virtually any appropriately detailed system or method.

### II. Method and System for Generating Ranked Referrals using a Referral Network

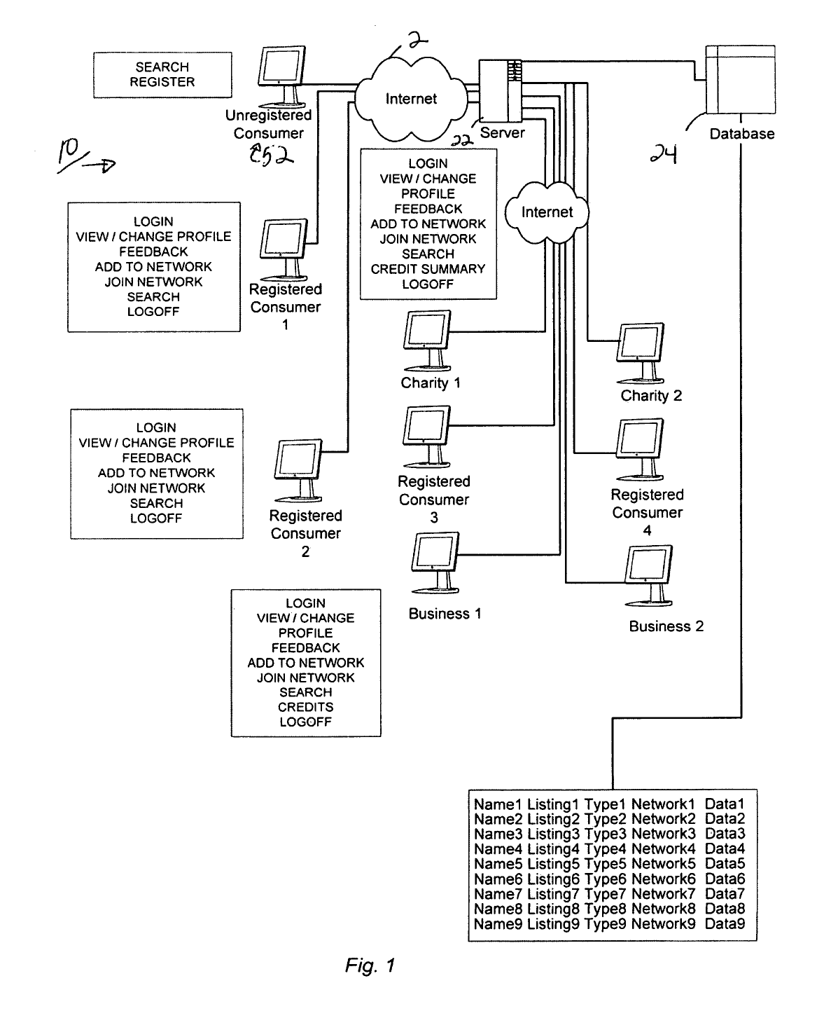

Referring to the drawings in greater detail, FIG. 1 is a schematic overview representing a network generating ranked referrals in accordance with a first aspect of the invention. An embodiment of the system illustrated in FIG. 1 is generally indicated by reference numeral 10. The system 10 for generating ranked referrals generally includes a conventional computer 20 with an input device (like a keyboard or mouse) and an output device (like a monitor or printer) associated with a first user such as a consumer in communication with a second computer 22 associated with the system 10, having a processor operating computer instructions contained within an electronic program 50 such as a website which interfaces with electronic information retrievably stored within a mass storage device in an organized format such as but not limited to a database 24.

According to one embodiment of the present invention, the method is implemented as a computer program, namely, as a plurality of coded instructions executed by a processor. Thus, for example, the method may be a cross-platform java application, a standalone application written in native code, a distinct process build into a server, or part of an application server accessible via thin client or web browser functionality. One of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution.

As indicated in FIG. 1, the referral process may begin when the consumer, using a client based computer 20, accesses the website 50 running on the second computer 22 through the Internet. Once accessed, the consumer, using the first computer 20, may select various system 10 parameters, such as keyword associated with another user, to search for another consumer, registered business, a charity or other nonprofit entity. Upon receipt of the various system parameters, the system will generate a ranked listing of consumers, businesses or charity's associated the provided parameters.

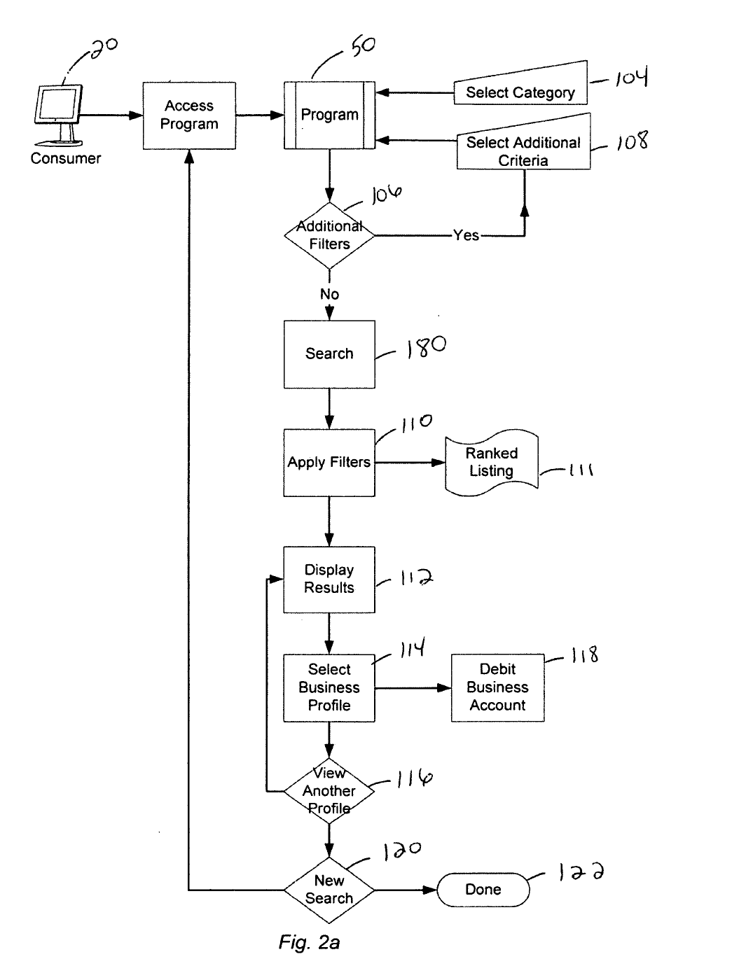

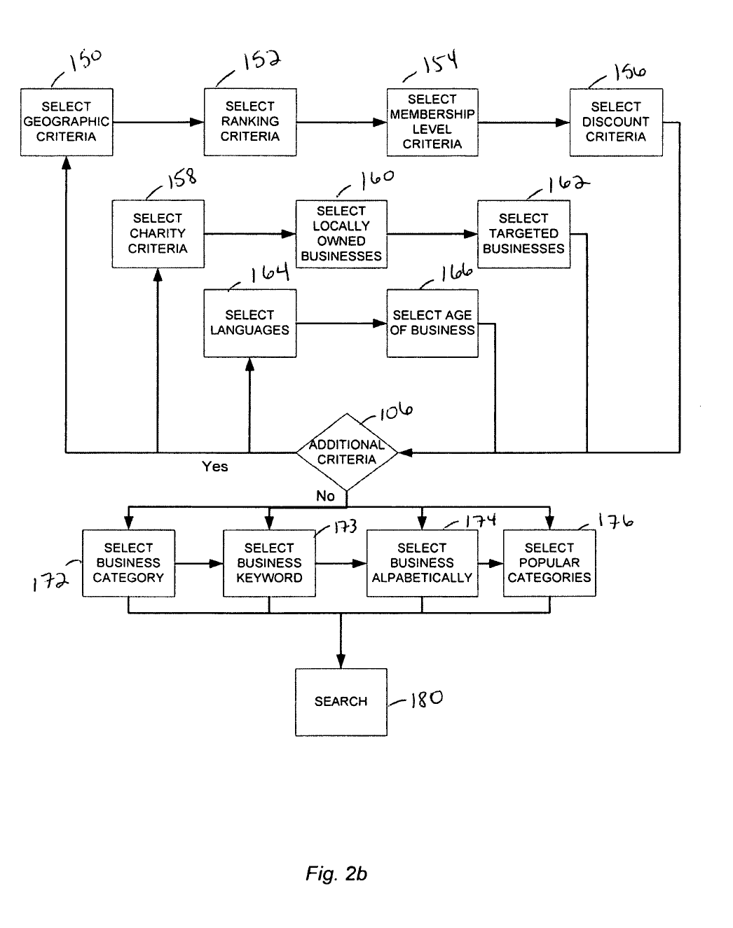

As illustrated in FIG. 2a, a flow chart illustrating steps performed by a consumer to locate a business provider using a private network with one or more preferred business is shown in which the consumer uses the computer 20, generally configured to operate as an application client, is placed in communication with the second system computer 22, generally configured as an application server. Once the website 50 is accessed, the consumer 20 may desire to search for other businesses by selecting 104 the desired business category and optionally selecting 106 additional search criteria 108 which may include, but is not limited to the criteria illustrated in FIG. 2b.

FIG. 2b includes geographic 150, ranking 152, membership type 154, discounts offered 156, charitable affiliations 158, and business demographical information like ownership 160, fluency in other languages, age of the business and whether the business is a targeted business. Alternatively or additionally, the user may select to limit the business by business category 172, business keyword 173 and alphabetically by name 174. While FIG. 2b illustrates some criteria, it is only illustrative of some of the search criteria which may be utilized by the system 10 and depending on the system 10 or other concerns, additional criteria may be added or removed for different business categories.

As further illustrated in FIG. 2a, Once the desired criteria has been selected 108, the system 10 may search 180 the stored website data contained within the database 24, optionally including business provider criteria, variable feedback rank and plural business listings, each listing associated with a registered member, and process 110 the website data for the selected criteria 108. The program is adapted to process the website data and filter 110 the website data based upon the supplied search criteria 108. Once processed 110, a business listing 111, including business provider criteria may be displayed 112, ranked in accordance with various system parameters stored within the database 24 including, but not limited to, a score calculated by the system 10 based in part on provided feedback, and based in part on the selected search criteria 108. Once the system 10 has determined the ranking of the matching businesses, a listing will be generated 111 by the system 10 for display 112 at the first computer 20, from which the first computer 20 maybe used to select 114 and review a business profile. Once a business profile is viewed 114 at the first computer 20, the system 10 will deduct or transfer 118 economic value contained within a portion of the available proceeds from the business debit account, previously configured.

From the profile screen further described below, the first computer 20 may display necessary business information for initiating a consumer transaction or the computer may be used to access the website 50 for navigating back to the displayed 112 ranked listing 111. The first computer can then be used to review 114 another business profile. In this way, multiple business profiles may be reviewed until completed 122 or until a particular listing meets the searchers requirements. Alternatively, a new search may be initiated 120, for the system to process according to the flow diagram of FIG. 2a.

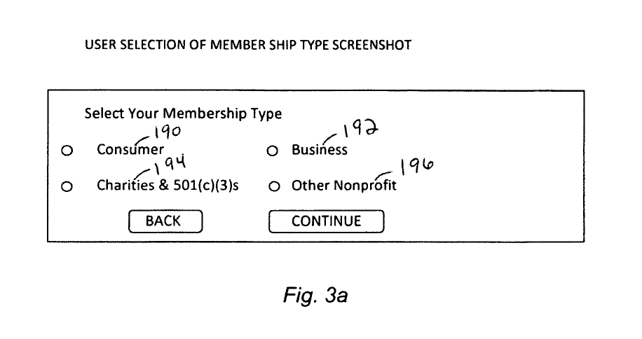

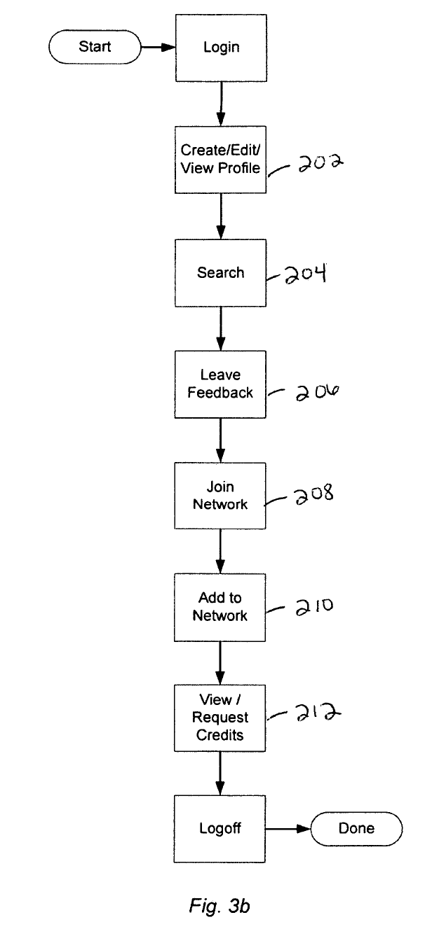

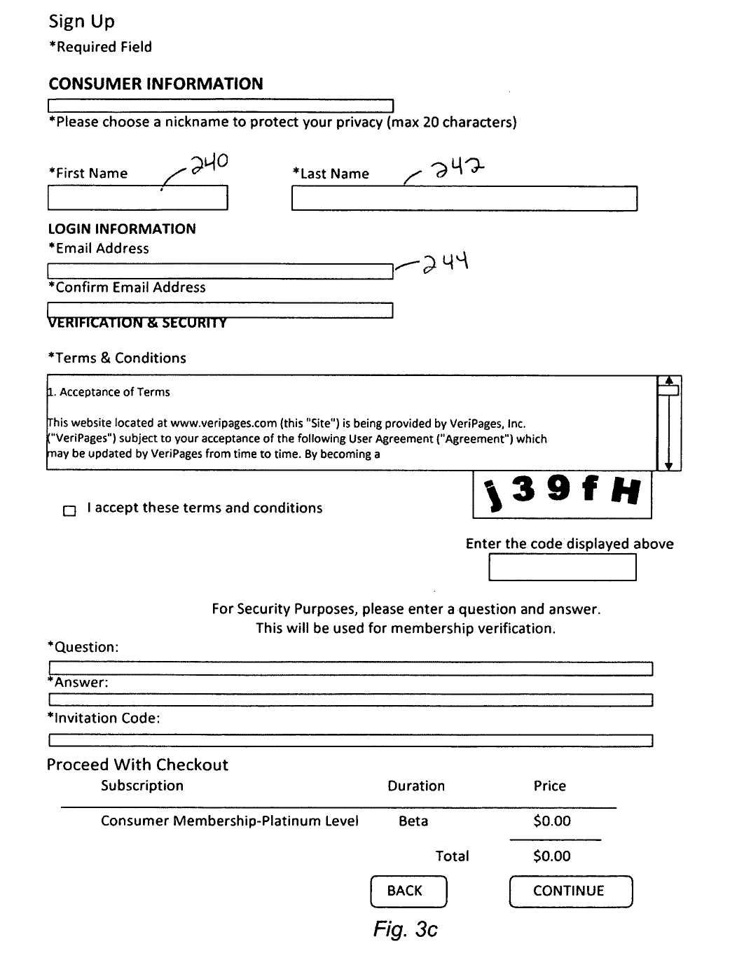

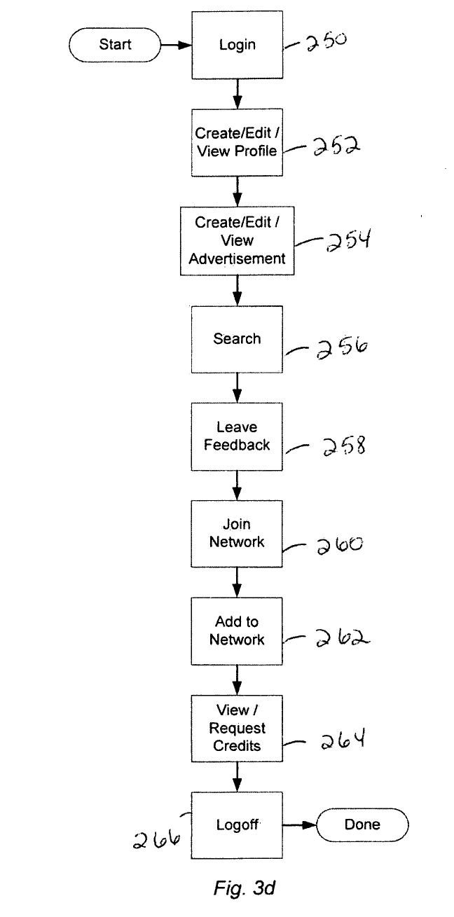

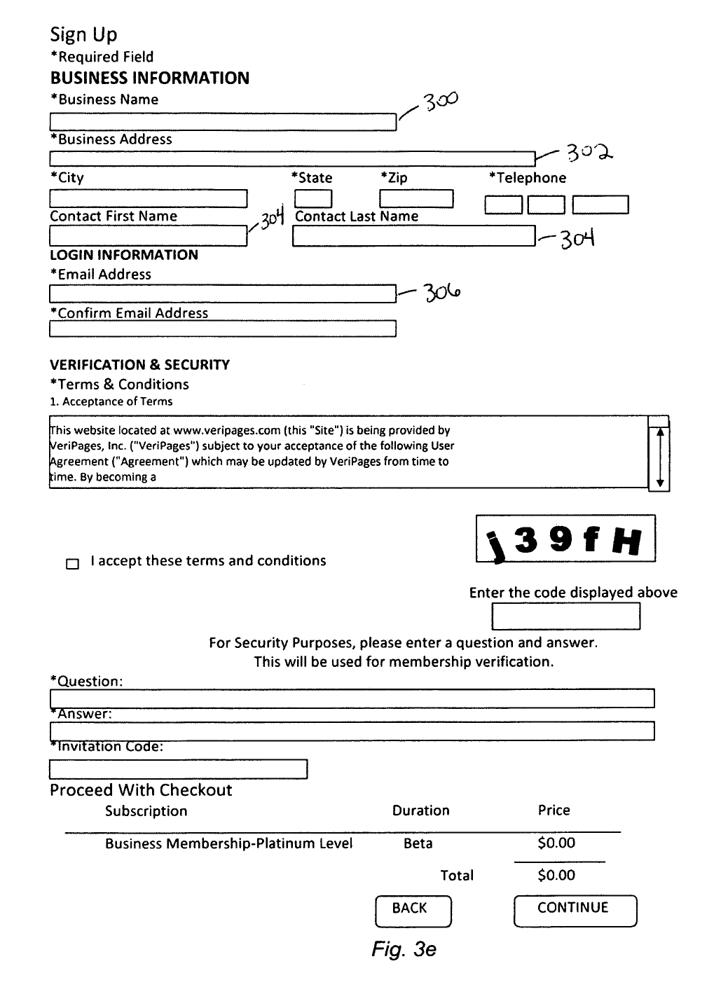

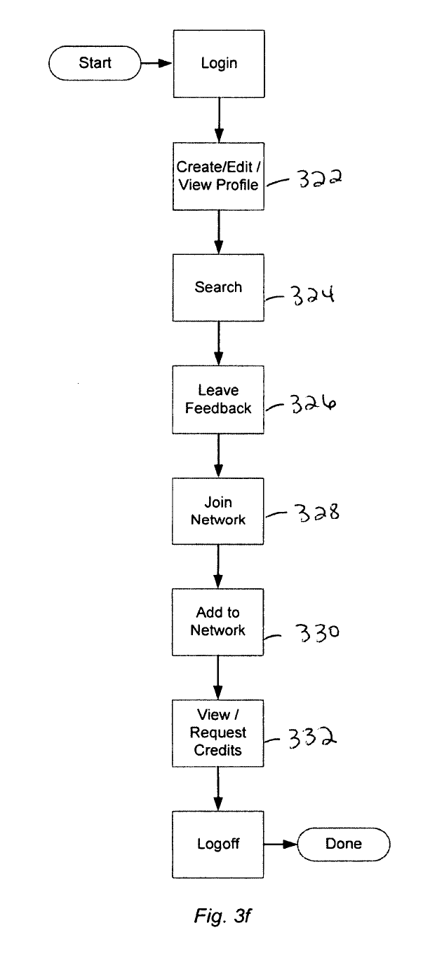

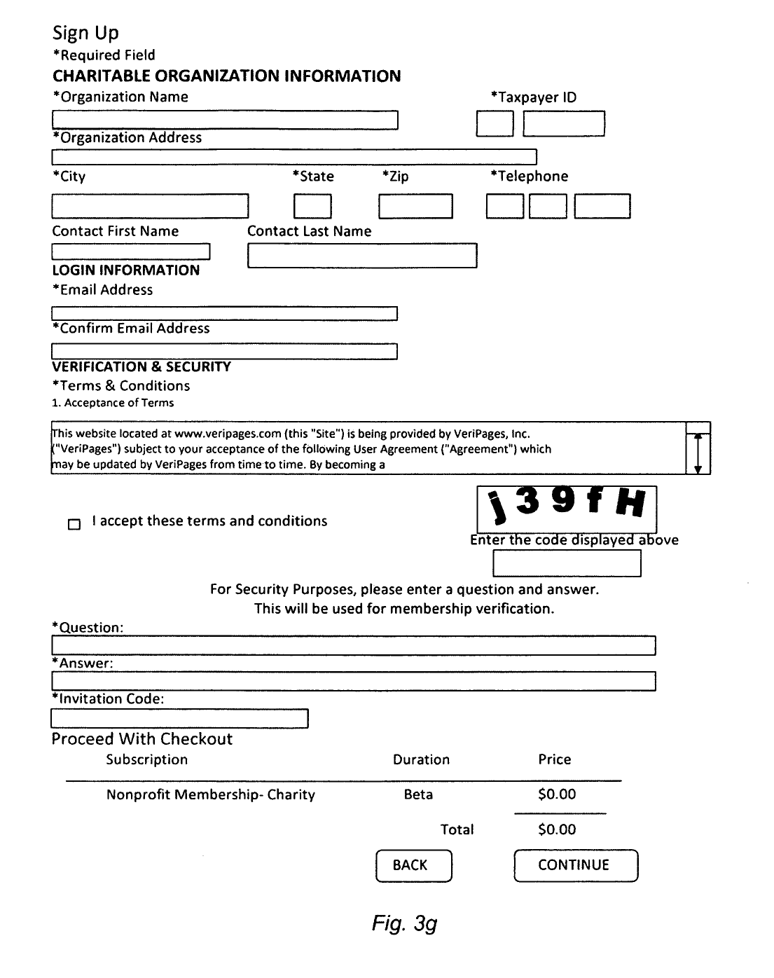

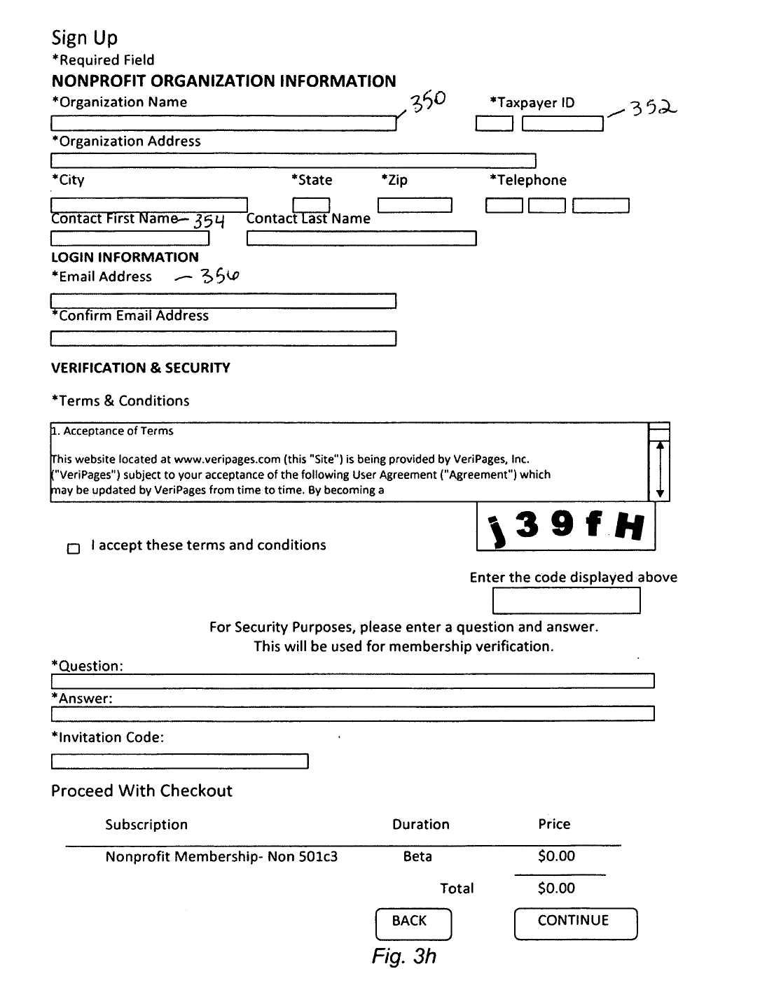

Generally, access to the website 50 is available to multiple users through the Internet, without being limited to registered members. However, as illustrated in FIG. 3a, a user may decide to register as a consumer 190, business 192, charity 194 or another non-profit organization 196. Within each category, the user may also decide between different levels of membership with the varying categories, such as but not limited to, standard, bronze, silver, gold and platinum.

If the user registers as a consumer 190, they will have access to additional system 10 features, including those illustrated in FIG. 3b such as, but not limited to, create, edit and view their profile 202, perform a business search 204, provide feedback 206, create a network, add users to their network 210, join another's network 208 and view or utilize 212 available system credits. During registration, the consumer generally indicates some basic contact information. By way of example, a simplified consumer sign up screen is illustrated in FIG. 3c, in which the consumer 190 may provide various items of information including first and last names 240, 242 and email address 244. To help verify the information provided is accurate, the sign up screen may contain different methods of verification that the information is accurate and that the user is authentic and credible.

Alternatively, the user may register as a business user 192, being provided access to additional system 10 features, including those illustrated in FIG. 3d such as but not limited to, create, edit and advertisement information 254, leave feedback, perform a business search 256, provide feedback 258, join an existing network 260, create a new network or add users 262 to their existing network and view or utilize 264 system credits. By way of example, a simplified business account sign up screen is illustrated in FIG. 3e in which the business user 192 may provide various items of information including business name 300, business address 302, business contact name 304 and a business email address 306. To help verify the information provided is accurate, the sign up screen may contain different methods of verification that the information is accurate and that the user is authentic and credible. The user 192 may also choose a membership level such as platinum, silver, or standard.

Alternatively, the user may decide to register a charitable organization 194, obtaining access to additional system features including those illustrated in FIG. 3f which include creating, editing and viewing the profile 322, searching 324, providing feedback 326, creating, joining 328 and adding additional members to an existing network 328 and view and request account credits 332. By way of example, a simplified charitable organization account sign up screen is illustrated in FIG. 3g, in which the charitable organization 194 may provide contact information, including the name 350, taxpayer identification number, 352 and contact name 354 and email address 356. To help verify the information provided is accurate, the sign up screen may contain different methods of verification that the information is accurate and that the user is authentic and credible. The charitable organization 192 may also choose a membership level such as platinum, silver, or standard. Alternatively, if the charity is not a designated 501(c) (3), the user may elect to sign-up using the other non-profit sign-up screen of FIG. 3h.

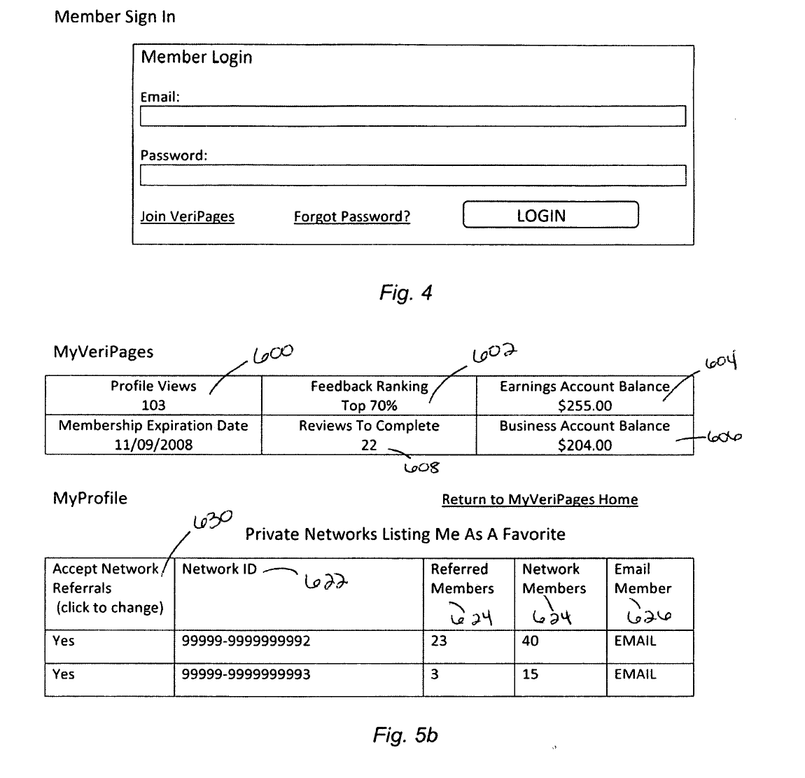

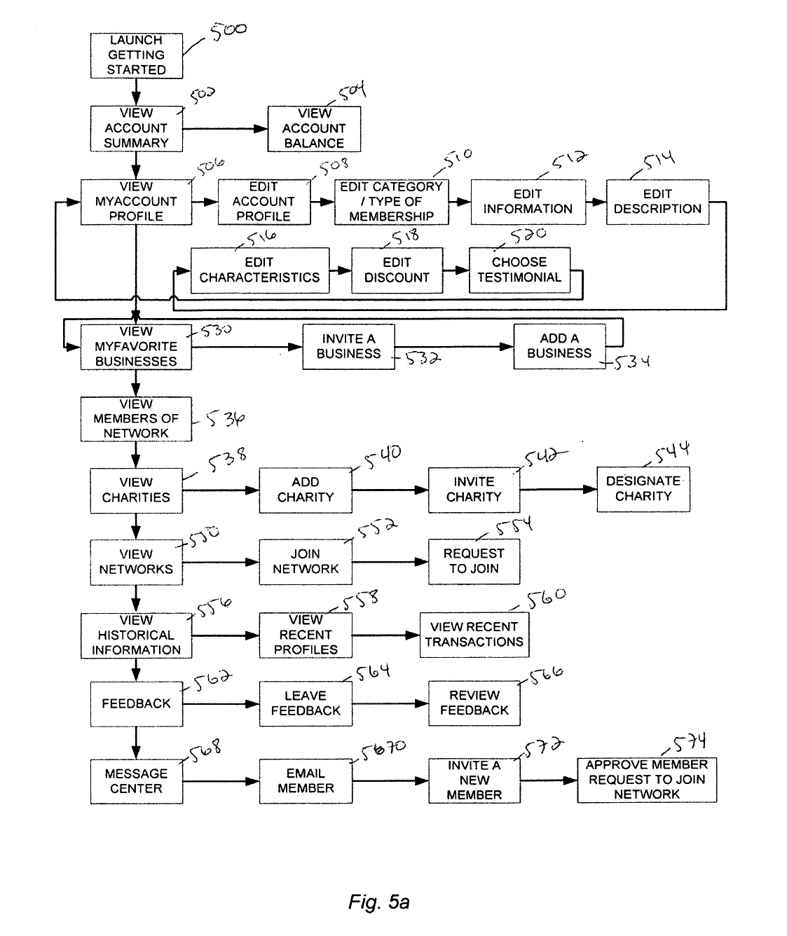

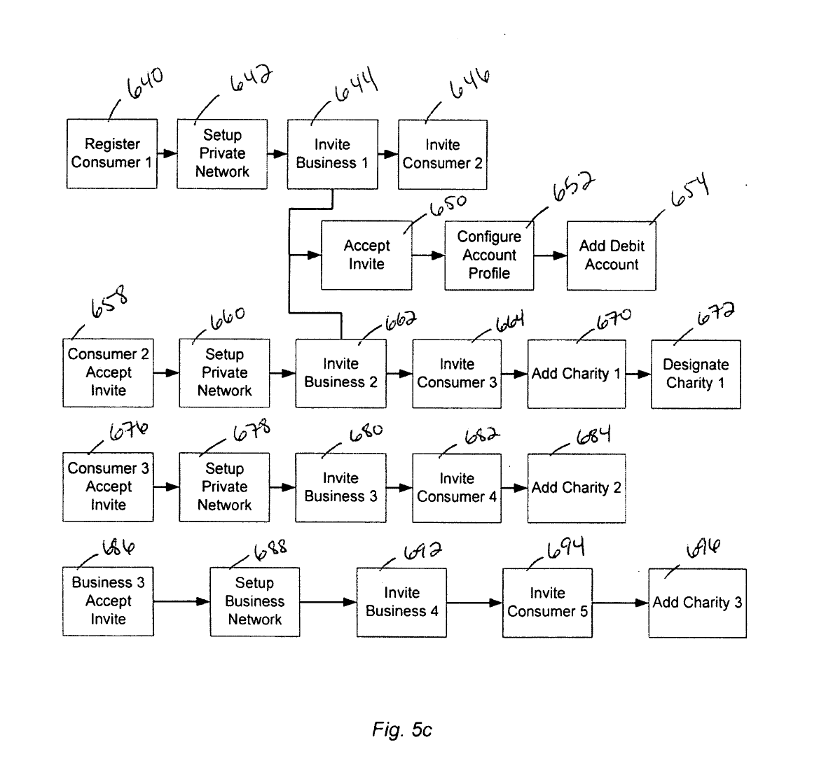

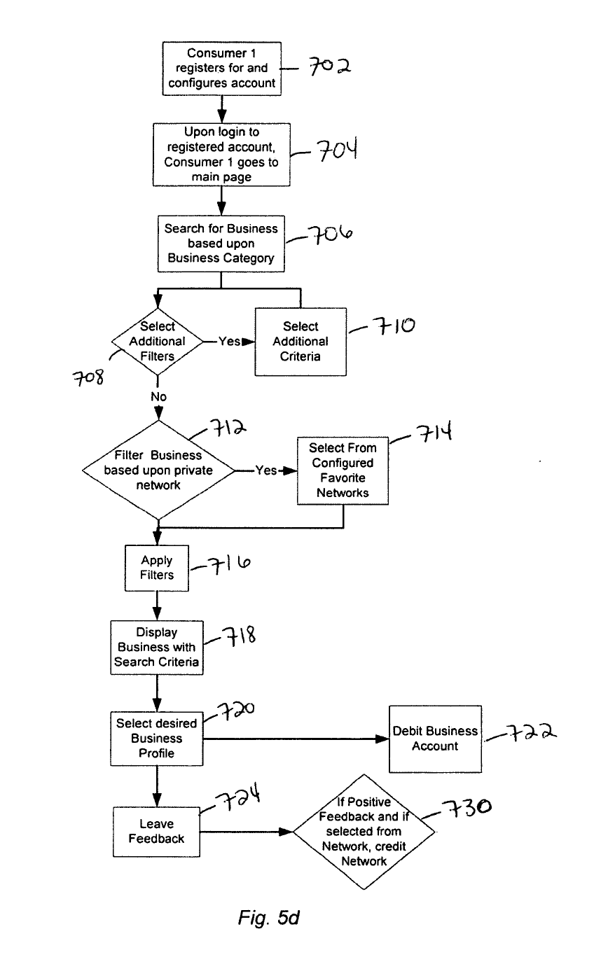

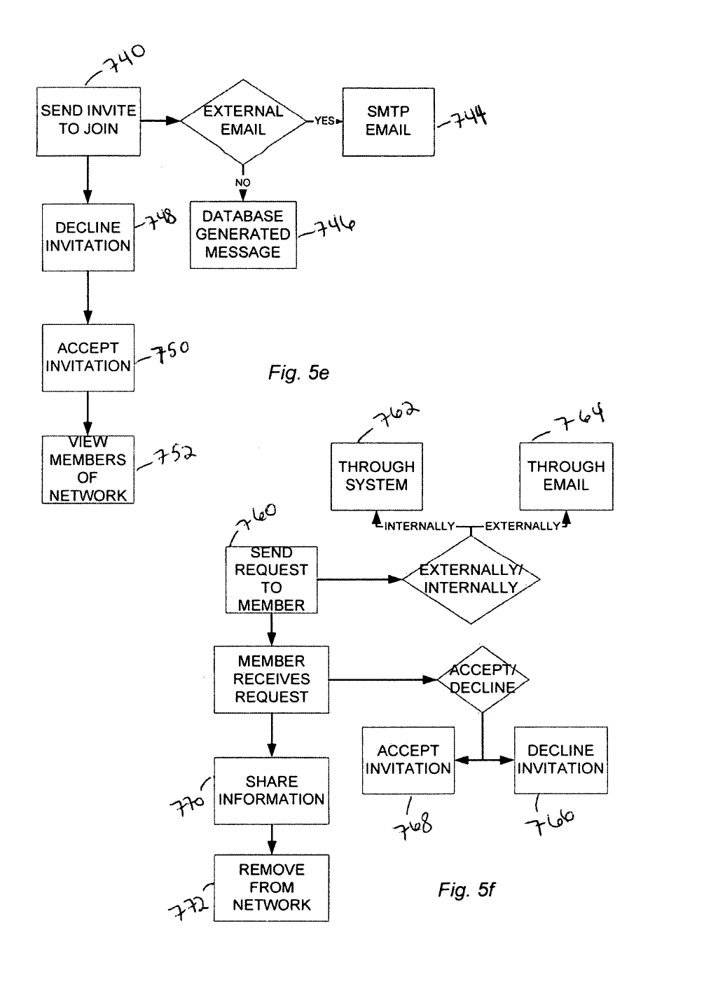

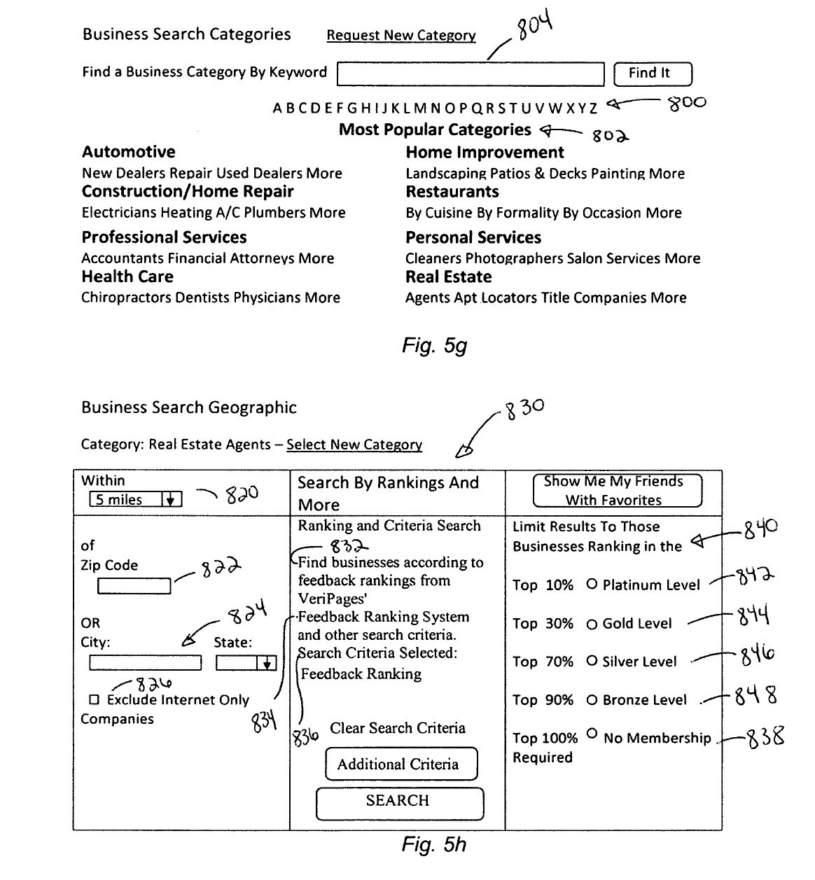

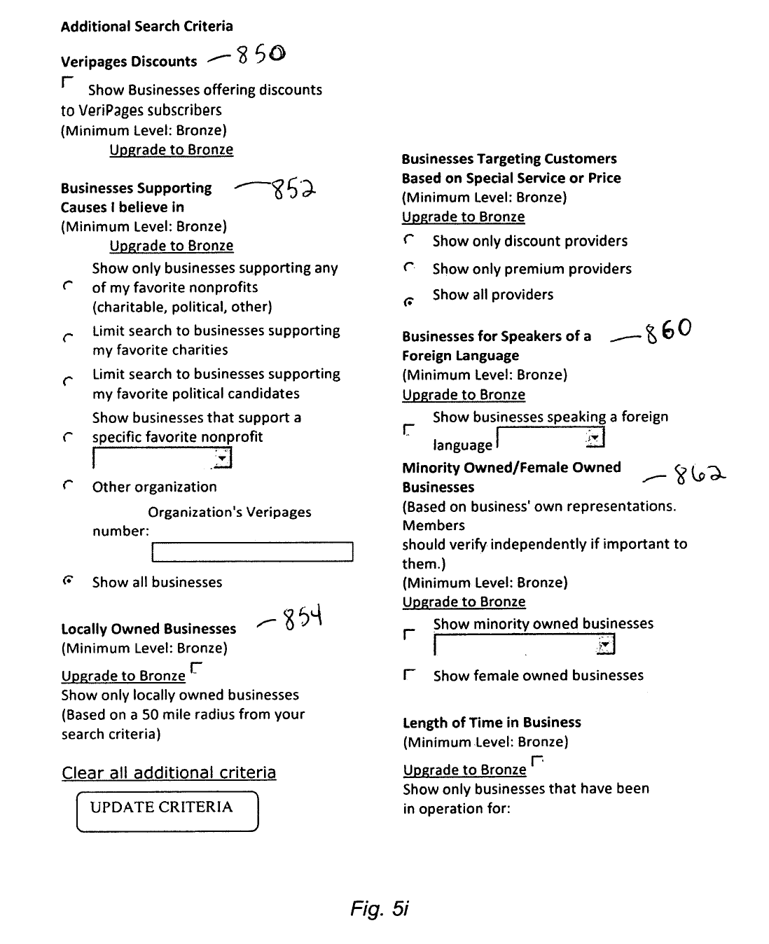

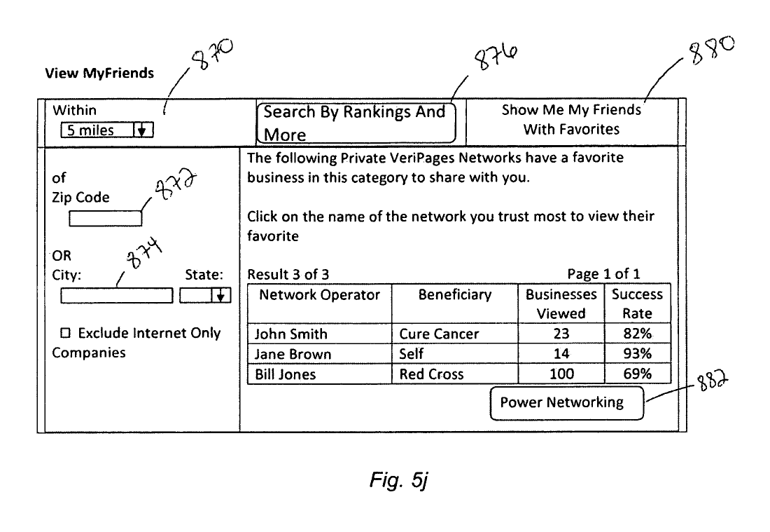

Once user 1 has registered as a consumer 190, business 192, charity 194 or other nonprofit 196, user 1 may login in to the website 50 using the exemplary login screen of FIG. 4. Once logged into the system 10, user 1 may be directed to their profile screen, from which they can initiate various system features, depending on the type of registration. Exemplary features are illustrated in FIG. 5a, which may be accessed from the user's profile page; however, as understood by those skilled in the art, these features are only some of the system features which may be utilized by the present system and maybe increased, modified or removed depending on the needs of the system 10.

If user 1 registers as a consumer, they may provide additional contact information and consumer preferences, creating a network with which they can invite, add or share with other members, or user 1 may also request to join a network of another member. If user 1 registers as a business, they may provide additional contact information, business provider criteria which may include a business preference with which other consumers or businesses may be matched. If the user registers as a charity, they may provide additional contact information and charitable criteria which may include charitable preferences with which consumers or businesses may be matched. Using the system 10 search feature, when a consumer searches for a business or charity, the system 10 may generate a ranked listing based upon the provided consumer preferences of businesses which are responsive to the consumer criteria including consumer preferences entered by the consumer using the input device at the computer and transmitted to the system via a computer network. In providing a search feature, specific software programming or code is utilized to identify search listings retrievably stored within the database matching the consumer criteria received from the consumer. As a result of the search feature, the business providers are matched with consumers responsive to the preferences provided by the business. The system may also rank the businesses based, at least in part, on any user recorded feedback.

Additional software or code is utilized by the website including code for sorting the matching search listings in the search result list with the consumer preferences identified within the search criteria, code to transmit the search result list to the consumer over the computer network and code to transfer the economic value from the business associated with the search listing when a business profile associated with the business provider is displayed by the consumer at the output device, in response to the entry of the search criteria and initiation of the search feature.

From User 1's profile screen, they may utilize the online tutorial under the getting started 500 feature in which the system 10 will walk User 1 through many of the steps needed to utilize the system 10 features. In addition, user 1 may view 502 the account summary screen and view any available account balance 504. As described above, during the sign up process, user 1 provided some basic contact information, however, to take full advantage of the system, User 1 may configure their account profile 506, by providing various account profile information items 508, reviewing and if desired, modify, the category or type of membership 510, providing additional profile related data 512.

If user 1 is a registered business, they may also configure the business description 514 along with any business characteristics 516, the type and amount of any promotional 518 discounts offered by the business to other users. A testimonial 520 may also be included for display on the business's profile page.

After the profile screen is initially configured, User 1 may review the profile information and make any desired additions, deletions or changes generally using the previously described method.

In addition, to configuring, reviewing and editing the profile information, User 1 may add 534 or invite 532 Business User 1 to join User 1's private network, which is an association of members invited or added to the system 10 and associated with User 1. In addition, to providing a referral network of affiliated members and businesses, User 1's private network, may allow User 1 to share in a portion of any system proceeds which may result to the system 10 from the referral process. Once Business User 1 has been added 534 or invited 532 to User 1's private network, Business User 1 will be displayed under User 1's favorite businesses 530.

In addition to businesses, User 1 may invite 572 other members to join its network. User 1 may also approve a request 574 from another system user, user 2, to add User 1 to user 2's private network, in which case, User 1 will be listed as a member of user 2's private network 536.

In addition to businesses, charities may also be added to the system 10. As further illustrated in FIG. 5a, User 1 may add 540 a new Charitable User 1 to the system and User 1 may invite 542 an existing system member, charity 2, to join User 1's private network. Once added to User 1's private network, User 1 may view 538 Charitable User 1 and 2 through User l's profile page. In addition, User 1 may designate 544 Charitable User 1 as a beneficiary, in such a way that Charitable User 1 receives a portion of the system proceeds which User 1 would otherwise be entitled to share, as discussed herein. In this way, system members may be encouraged to initiate consumer transactions with businesses which shared common charitable preferences.

In addition to viewing businesses 530, members 536 and charities 538, User 1 may also view all private networks 550 of which User 1 is a member. Each private network may be associated with a unique system identifier. If User 1 wishes to join the private network of another member, user 3, User 1 can join 552 the network directly by providing the unique network identifier associated with user 3's private network. Alternatively, if User 1 does not know user 3's unique private network identifier, User 1 may send a request 554 to join user 3's private network, in which case user 3 may approve or decline User 1's request as further described below.

System historical information may also be viewed 556, including recently viewed profiles 558, and recent transactions 560. Feedback associated with User 1 may also be viewed 562 and any uncompleted feedback questionnaires may be stored by the system, for review and completion 564 by User 1. Additionally, User 1 may review any completed feedback 566, which User 1 has completed regarding other system users.

A messaging center feature 568 is also provide which provides a way for other system users to communicate with User 1 and for User 1 to electronically communicate 570 with other members, or for User 1 to invite new members or approve member network requests 574. Invites, emails, and system generated message may be initiated using standard electronic messaging protocols, including those utilized by computer email programs, standard message notifications, database messages and other generally known procedures.

An exemplary summary screen is illustrated in FIG. 5b in which User 1 may view the number of times their profile has been viewed 600. In addition, statistical information related to User 1's profile including User I's ranking 602, as a percentage or raw score, in comparison to other system users. This feedback ranking is determined by the system at least partly upon the results of the questionnaires generated and transmitted to the member by the system 10 in response to viewing a member's profile, completed by member whose profile was viewed and recorded by the system 10. A listing of uncompleted or incomplete feedback questionnaires 608 may also be indicated. The summary screen also includes an account balance, both in terms of earnings 604 and amounts deducted 606 from the User I's configured account. In addition, the profile screen of FIG. 5b, includes a list of private networks 620 which have listed the user as a favorite including the network identifier 622, the listing of referred members 624, the number of network members 626 and an email address 626 for the network administrator. User 1 may also indicate its preferences related to the listing networks 620 by denying or accepting referrals 630 from the listing networks 620.

FIG. 5c provides an exemplary illustration of the sharing of resources between various system 10 members, with registered 640 Consumer 1, creating 642 a private network and transmitting an invitation 644, 646 to Business 1 and Consumer 2 to join Consumer 1's private network. Business 1 may be any business including those generally listed in the phone and various online directories who may desire to have online referrals from other consumers or businesses for products or services. Consumers may be any general consumer, who obtains products or services from other businesses or even general consumers interested in creating a social network to share business referrals.

Upon the acceptance 650 of the invitation by Business 1, Business 1 may configure its account profile 652, including designating a debit account 654 from which the system 10 may withdraw necessary economic resources, such as money or credits, based upon the viewing of Business 1's profile. The amount to be withdrawn as a result of the referral may be variable depending on several factors including, but not limited to, the business provided criteria and consumer provided criteria. If Consumer 2 accepts 658 Consumer 1's invitation, Consumer 2 may simply request to be added to Consumer 1's private network. Alternatively, Consumer 2 may create its own private network 660 and invite 662, 664, 670 Business 2, Consumer 3 and Charity 1 to join Consumer 2's private network.

In creating a private network 660, Consumer 2 becomes the owner or administrator of the network and by adding other members, designates the added members as a referral partner, in which the added member's profile maybe reviewed during a search of the system 10 by other users, if the added member's provided criteria meets the selected search criteria.

Upon signing up as a business member and configuring their account profiles, Business 1 and Business 2 would designate a debit account 654 having resources from which the system will deduct, when the respective member's profile is viewed. As a result of featuring Business 2 (whose profile is viewed), Consumer 2, the network operator, may receive a portion of the proceeds collected by the system 10. The proceeds are obtained from the system 10 as a result of matching the business, having preferences with the consumer provided consumer criteria. If the match occurred as a result of searching Consumer 2's private network and if the searching consumer and business complete a feedback survey related to a purchase transaction and if the feedback score, as determined by the system 10, is positive, Consumer 2 may be entitled to share in a portion of the proceeds obtained from Business 2's debit account.

Alternatively, Consumer 2 may designate 672 Charity 1 as a beneficiary. As a result of being designated as a beneficiary by Consumer 2, any proceeds which are earned by Consumer 2 may be credited to Charity 1's earnings account configured during Charity 1's sign up process.

Additionally, Consumer 3 may accept 676 Consumer 2's invitation to join Consumer 2's network, additionally configuring 678 its own private network, adding 684 Charity 2 and inviting 680, 682 Business 3 and Consumer 4 to join its network. In this example, even though Consumer 3 added 684 Charity 2 to Consumer 3's private network, without designating Charity 3 as a beneficiary, Charity 3 would not receive any proceeds obtained as a result of the search of Consumer 3's private referral network.

In addition to consumer's adding businesses, a business may invite another business, consumer or charity to join its private network as illustrated in FIG. 5c. After Business 3 accepts the invitation 686 from Consumer 3, registering an account and configuring 688 an account profile, Business 3 may invite 692, 694, 696 Business 4, Consumer 5 and Charity 3 to Business 3's private network. Business 3 can also designate Charity 3 as a beneficiary, in which case, Charity 3 would benefit from any referrals made by Business 3. In this way, a search of the system can be conducted to determine which businesses support various charities or charitable causes.

FIG. 5d illustrates an alternative business search in which Consumer 1 is registered and logged 702 into the system 10 using a unique user identification and secure password. Upon authentication of Consumer 1, the user profile screen may be displayed 704 and if not previously configured, configured providing intuitive access to a number of system features as discussed previously and further explained below. As previously indicated, during the alternative search, Consumer 1 may search for a business based upon the business category 706 and additional search criteria 710 which would be used to filter-out 708 any unmatched, registered members from the search results. In this way, the search results will only display businesses whose preferences and criteria match those provided by Consumer 1. This may include filtering businesses based upon their feedback score. In addition, Consumer 1 may also search businesses based upon their association with a private network 712 or previously configured favorite network 714. In this way, Consumer 1 may obtain a referral from another known private network or from a member i.e. consumer, business or charity, with whom Consumer 1 has a preference for, such as a favorite or trusted friend or business.

Once the system has processed 716 the search request and displayed 718 a list of businesses, also referred to herein as a search listing, whose preferences match those provided by Consumer 1, specific business listings may be selected 720 for viewing their profile at which time the system would debit 722 the configured Business Debit Account. After the profile of the business has been displayed or viewed 720 at the output device, the system 10 may generate a feedback questionnaire, forwarding the same to both Consumer 1 and the selected business. The feedback questionnaire may be completed using the input device of the computer, the system recording and evaluating the questionnaire using code executed by the computer, the feedback rating being adjusted, by the program, in response the completed feedback questionnaire. Additional software or code may be utilized for matching the business provider with keywords supplied by the consumer during the search feature.

Upon the completion of a purchase transaction, the selected business and Consumer 1 may complete the feedback questionnaire 724. If the selected business leaves non-negative feedback 724 for Consumer 1, the selected network 730, which referred the selected business, may receive a portion of the proceeds which are obtained as a result of the search process. In this way, the system provides an income generating opportunity for referring members. If the selected network owner had designated a Charity as a beneficiary, the Charity would receive credit as a result of the search process in addition to or in lieu of the network.

As an example of a typical invitation to join a private network, FIG. 5e illustrates that an invitation to join 740 may be sent to a member using an external email program 744, such as but not limited to, Outlook® and Outlook Express® (Microsoft Corporation, Redmond Wash.). This may also be utilized to send an invitation to a non-member, who is not registered by the system and for whom there is insufficient contact information.

Alternatively, an invitation may be sent to another system member directly, where the message is at least in part generated by the system 10 in response to a request by a registered member with information from which the system can identify the recipient, such as their member number. As is known to those skilled in the art, electronic mail is generally received by email servers and directed to individual mailboxes. Various servers, protocols, and systems can be used to receive and store electronic mail; exemplary systems include but are not limited to Microsoft Exchange Server, implementations of the Post Office Protocol Version 3 (POP3), and implementations of Internet Messaging Access Protocol (IMAP). While each of these systems has an associated time delay associated with receiving and forwarding the email, by sending the invitation directly through the system 10, using the database to record and forward the request 746 to the account holder's messaging center, the invitation maybe more promptly delivered to the user, allowing the message to be responded to quickly. The recipient of the invitation can accept 750 the invitation or decline 748 the invitation. By default, unless the recipient accepts the invitation, it will be treated as being declined. If the invitation is accepted, the recipient will be added to private network of the inviting member for sharing referrals and viewing 752 of other network members or other users through a search.

A request to join the private network of another system user 760 is illustrated in FIG. 5f, in which the requester sends a request 762 or through a third party email program 764. If the request is sent 762 through the system 10, a request form may be utilized in which the requester completes relevant information including a unique member identifier, associated with the member whose private network the requester wishes to join. Because the request was sent through the system, some of the member identifying information may be provided by the system 10. Once the request to join has been sent 760, the recipient may accept the request 768 or decline the request 766. Once the member has joined the private network, additional information may be shared 770 between members of the private network. As the private network administrator, the recipient may remove 772 the requesting member from their private network at a later time. Because information regarding the administrator of the private network may be displayed along with the results of a search, the request to join may be the result of the requesting parties search for businesses based upon matching the various selected consumer criteria with the business provided criteria by the system 10. Results of the search may be displayed within a results window along with listing of networks of which they are a member along with a feature for generating a requesting to join the business's private network. In general, a user may belong to multiple networks or no networks at all.

Generally, a member logs into the website 50 and selects location and the type of business they are seeking either by viewing a menu of business categories or searching for a business category by keyword. An exemplary business category search window is illustrated in FIG. 5g in which a searcher can select a business category alphabetically 800, topically based upon business category 802 or by keyword 804. The search may then be narrowed based upon additional geographic characteristics such as those illustrated in FIG. 5h, including nearby businesses 820, postal code 822 or city and state 824. In addition, business may be excluded 826 based upon certain criteria such as, but not limited to, whether they are an internet based business. In an effort to promote full system participation, the system 10 may provide additional benefits to those who have greater membership levels, including prevent unpaid members from excluding any members 838, limiting bronze members to exclude only up to ten percent (10%) 848 of the business from the search (including the top 90% of the businesses within a category), a limit of thirty percent (30%) for silver members 846 (top 70%), a limit of seventy percent (70%) for gold members 844 and up to ninety percent (90%) for platinum members 842.

Results generated by the system 10, based upon the selected criteria, may also be sorted based upon the business's feedback ranking 830 and membership level 840. The listings may be sorted based upon the average system generated ranking 832, the business's raw feedback score from specific private networks 834, the average raw score of all businesses within a specific private network, the type of private network administrator, whether searchers are a consumer, business or charitable organization. In addition, the searcher may select additional search criteria 836.

Additional criteria may be provided by selecting the add criteria in which case a popup window may appear in which the searcher may provide additional search options such as those illustrated in FIG. 5j and FIG. 2b. For example, the searcher may include system promotional or member discounts 850, charitable affiliations 852 like the American Cancer Society, foreign languages 860 spoken, business owner demographics like local 854, female or minority owned 862 businesses.

In addition to searching for businesses, the system 10 may also allow system users to search for other members based upon geography including distance 870, postal code 872, city and state 874, rankings 876 or other selected criteria as illustrated in FIG. 5k. Some of the additional criteria, may include a listing of friends with favorites 880, allowing the member to view private networks previously associated with the member, and view some of the information and statistical data related to the “friend's” private network.

From the search page, the searcher may also click on the “Show Me MyFriends with Favorites” feature 880, which will reveal a list of private networks the searcher belongs to and whose private network operators have a favorite business in that category and zip code range. If the searcher selects one of the private networks listed, then the profile of a favorite business in the searched category will appear. If the searcher does not see a private network that they want to rely upon, they may choose the “Power Network” 882 feature and a list of private networks that the searcher belongs to and that have members with a favorite business which matches the provided search criteria, in the searched business category, will appear. Selecting the “Power Networking” 882 feature again will reveal the private networks with members who have members in their private network with a favorite business which matches the provided criteria. Selecting the “Power Networking” 882 feature again will continue to review the next successive level of matching members within the most recent network listing.

Once the searcher has completed providing their criteria which includes one or more preferences, the searcher may submit the information to the system 10 by clicking on the Search button, to generate the list of business providers who have preferences which are responsive to the criteria provided by the consumer. The listing generated by the system 10, may allowing the searcher to select a particular business provider listing and view their previously configured profile. In addition to viewing the business profile, the searcher may also add the business as a favorite to the searcher's private network as previously described.

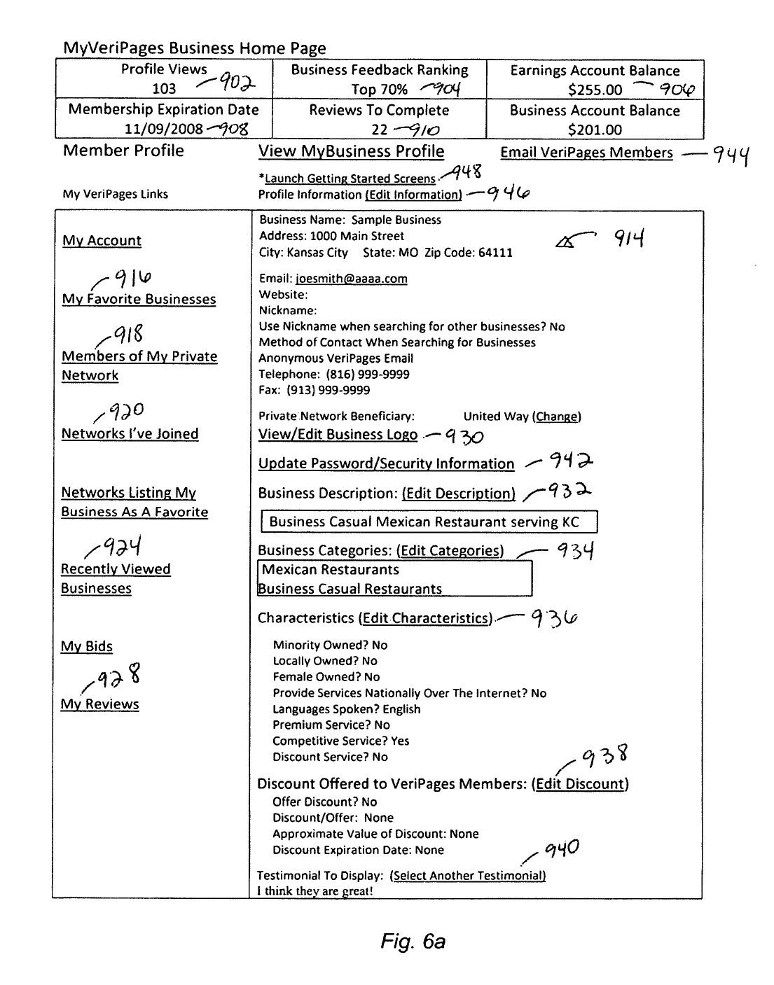

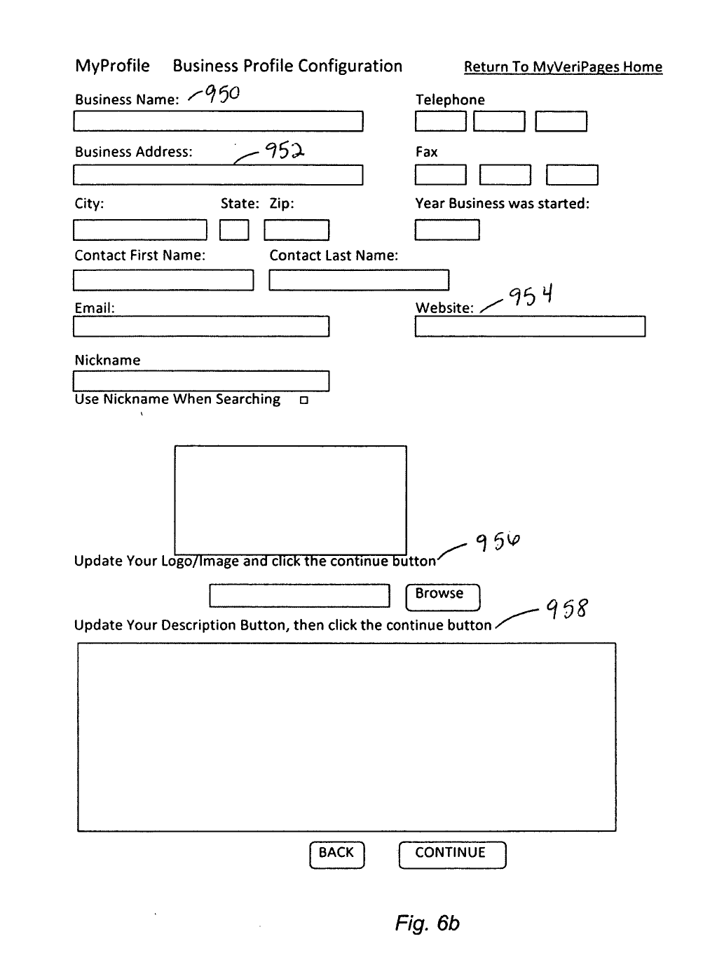

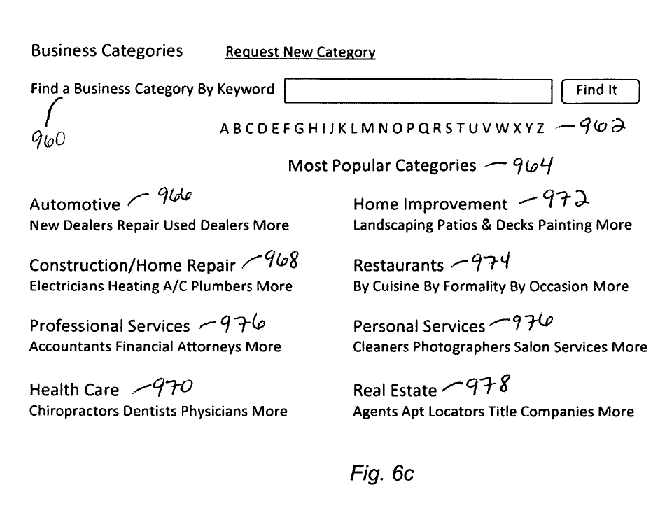

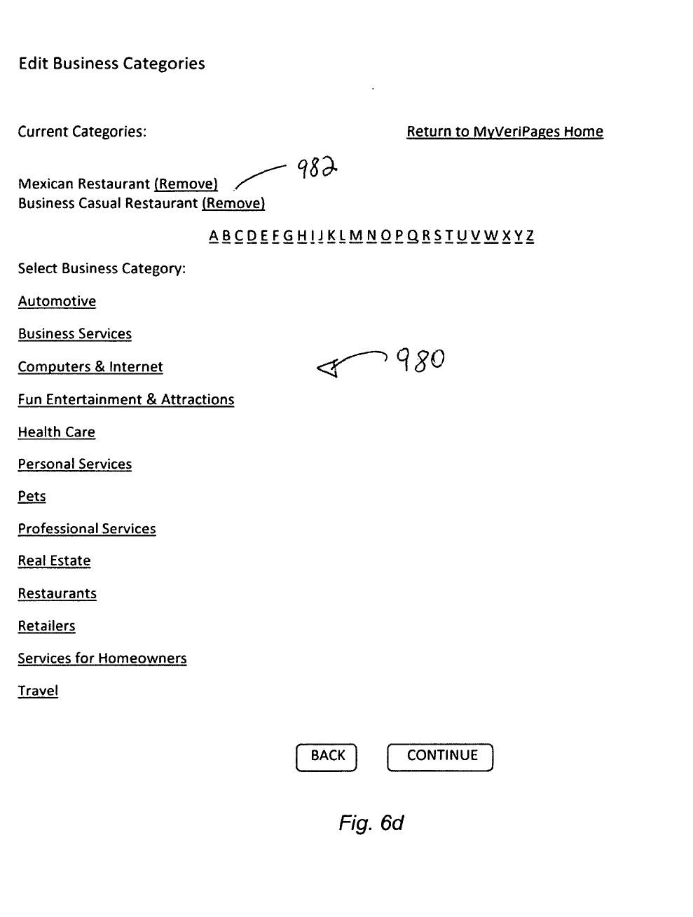

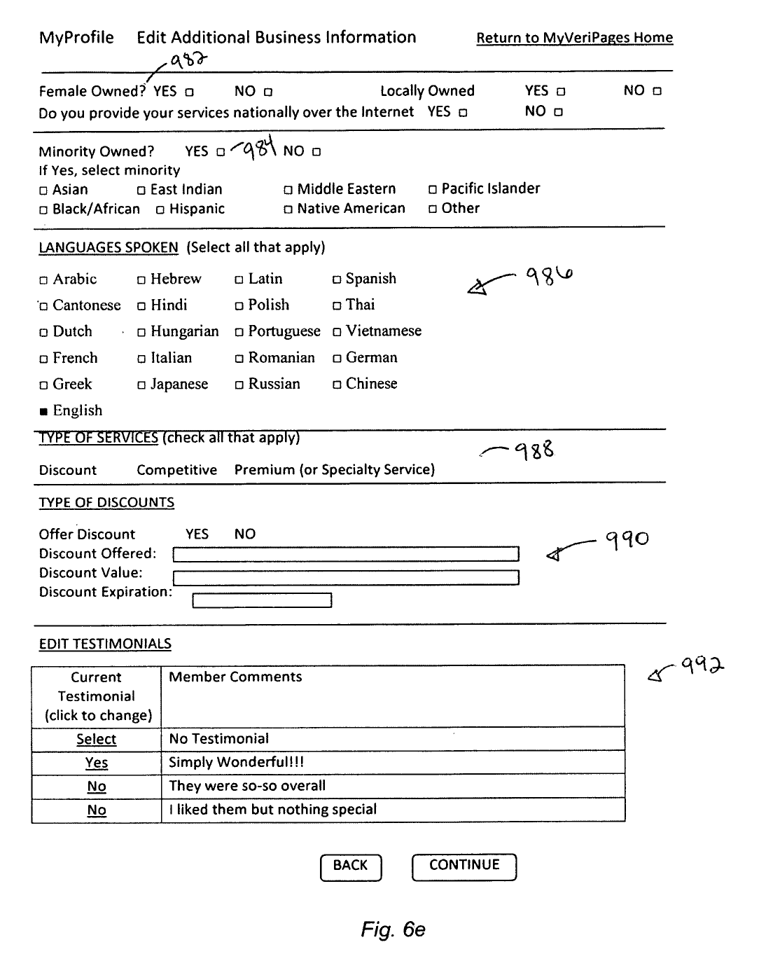

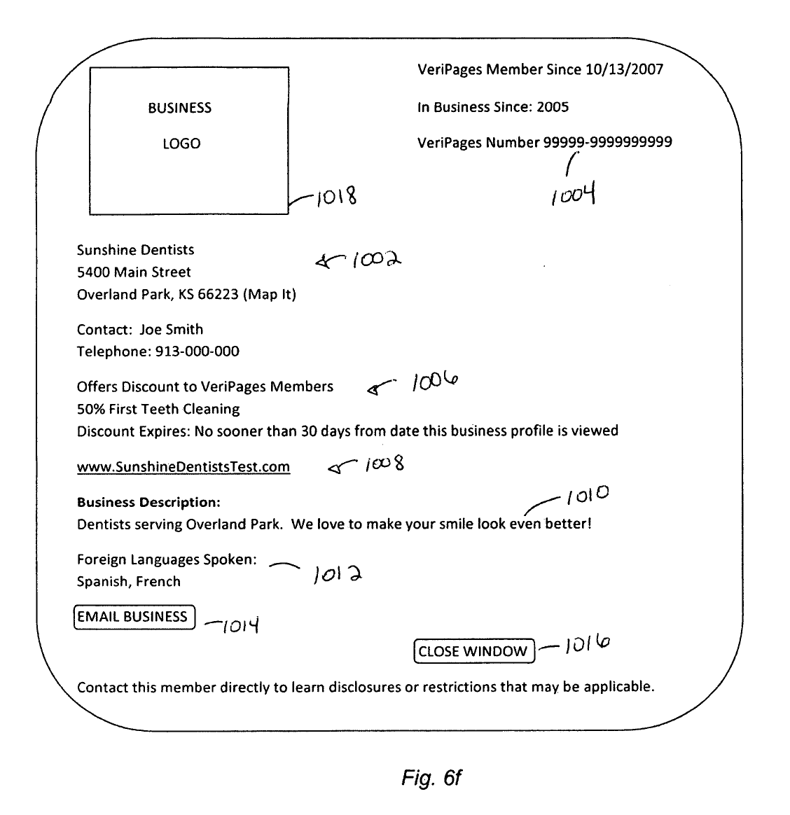

Once Business User 1 has been registered and logged into the system, Business User 1 can use, review or edit various system features like those illustrated in the Business Profile screen of FIG. 6a. On the profile screen, Business user 1 can view statistics related to their business listing, including the number of times its profile has been reviewed 902, its feedback ranking 904, its account balance 906, membership expiration date 908 and the number of feedback questionnaires which need to be completed 910. In addition, Business user 1 can review, update and add its contact information 914, favorite businesses 916, private network members 918, joined networks 920, historical transactions including recently viewed businesses 924, bids 926 and reviews 928. In addition, the business can edit 946 or configure their profile including their logo 930, description 932, categories 934, characteristics 936, testimonials 940, and promotional discounts 938. System features may also be utilized, including launch system help screens 948, change or update security information 942, email other system members 944.

All registered members have the ability to create a private network with favorite businesses 916. However, upon initially signing-up, the member must configure the private network by Adding Favorite Businesses 916 and inviting other members 918 to join their private network. Adding a Favorite Business 916 may be accomplished in several ways including using the unique system identifier to add the business. This number may be provided by the business itself. A private network administrator may add the business by typing in this number and all of the business categories for which the business is a member may be added to the private network. In addition, a business may be added to the private network when the private network administrator selects Recently Viewed Businesses 924. Within the displayed listing is an Add Business as Favorite feature which will enable the business to be added as a favorite to the private network, but only in the category which was displayed when the business listing was viewed. The business may also be added to the private network as a favorite by sending an email 944 to the business to invite them to join the private network. If the business accepts the invitation, the business will automatically be added to the private network for all business categories the business has listed. Optionally, the inviting member may earn a portion of the system proceeds which were deducted from the business during the sign-up process.

In addition, to Adding a Business as a Favorite, the system 10 may generate a listing of all Business Favorites 916 added to private network including the business category which the business is listed within the private network, the number of times other members of the private network have viewed the businesses profile. In addition, the private network administrator may utilize the hide/unhide feature associated with a favorite business, disabling a business from appearing to other private network members. A remove favorite business feature is also available, which allows the private network administrator to remove the favorite business from its private network with regard to one or more categories.

In addition to businesses, charities and other members may be added to the private network by the private network administrator by invitation and by using the member's unique system identifier. The member may also be removed from the private network by the private network administrator.

A sample profile configuration screen is illustrated in FIG. 6b which includes standard business information like name 950 and address 952. In addition, the Business user 1 may edit, configure or update business information such as business related website 954, logo 956 and a description of the business 958. Depending on the subscription level, some of the business information may not be available or if available, may be limited.

As illustrated in FIG. 6c, most business categories are arranged within the system topically 964, alphabetically 962 and based upon keywords 960. Using the topical index 964, the listings may be organized based upon common consumer categories, including but not limited to, automotive 966, construction 968, services 976 (both professional and personal), health care 970, home improvement 972, restaurants 974, and real estate 978. A business may be listed in more than one category and if a business wishes to add, update or edit their business category, they may use the Edit Business Category screen illustrated in FIG. 6d to associate the business with one or more commonly used categories 980 or remove their business from one or more categories 982.

Additional business information may be provided using the Additional Business Criteria screen of FIG. 6e which includes business demographical information like minority or female ownership 984, 982 or to identify if the business is multilingual 986. Select the Testimonial 992 is another feature which may be configured, the testimonial taken from comments made by consumers during the completion of the feedback questionnaire; the business may choose to display these comments on their profile page for viewing by other system users. Optionally, if the profile is viewed through its association with the private network, the testimonial of the private network administrator may be used. Another feature of the system 10 is that the comparative quality of the goods or services may be designated 988 during configuration of the profile such as premium or discount provider. In addition, the profile may state whether the business offers discounts 990 or promotions to other members or which charitable causes or organizations the business supports.

One embodiment of a Business Profile screen is illustrated in FIG. 6f, in which the business contact information 1002 is visible along with the unique system identifier 1004 from which the user my send a message to the business or add the business as a favorite to the user's private network. In addition to general contact information 1002, the profile screen identifies any available member discounts 1006, the business website 1008, the business description 1010 and languages 1012 with which the business is fluent. Depending on the level of membership, the business may also provide a logo to be displayed. Each profile screen also allows the user to send an email 1014 directly to the business through the system 10 and the user may close 1016 the profile screen.

In addition, business may block all members or just certain types of members from viewing their business profiles, which would reduce the number of unwanted views, corresponding to a debit from the business's debit account. However, even if a business has blocked some members from viewing their profile, a member may still view the profile by entering the businesses unique system identifier 1004 or the profile may be displayed by reviewing the list of recently viewed businesses 924.

As a result of reviewing a business's profile, the system, also allows consumer business and charitable members, to provide feedback related to recent profile reviews and any associated business transaction associated with the review. When the member accesses their home page, such as the one illustrated in FIG. 6a, the user may be reminded that there are a number of incomplete feedback questionnaires which need to be completed. When they select My Reviews feature 928, a listing of recent questionnaires which need to be completed. The system may prompt the user to complete feedback of businesses and consumers. If the member selects the complete feedback of businesses feature, a table listing all businesses associated with uncompleted feedback may appear allowing the member to use the computer and an input device like a mouse or keyboard, to select the name of the business for which the member desires to review. Once the member has selected which business to provide feedback, the feedback survey will appear for the member to complete. Once the member completes the feedback survey and selects the Submit Feedback feature, the system records the data associated with the feedback including the member's name and system identifier, whether a business transaction was associated with the feedback, whether the reviewer had requested to leave feedback without viewing the business profile and the date the feedback is submitted to the system 10. After the feedback is submitted, the reviewer may update and edit the submitted feedback. The member may be prompted to complete additional surveys chronologically until all uncompleted feedback surveys have been completed or the member indicates they are done with their reviews.

The member can also complete or edit the feedback of consumers and review any feedback related to the member. One of the benefits of providing recording member feedback is that it allows various businesses, consumers and charities to be ranked according to member feedback, the feedback being scored by the system and available to other members during their search for business providers matching specific consumer criteria. The feedback feature also allows referring private networks to share in at least a portion of the proceeds available from the system as a result of the business profile being viewed, which also helps to encourage consumer feedback.

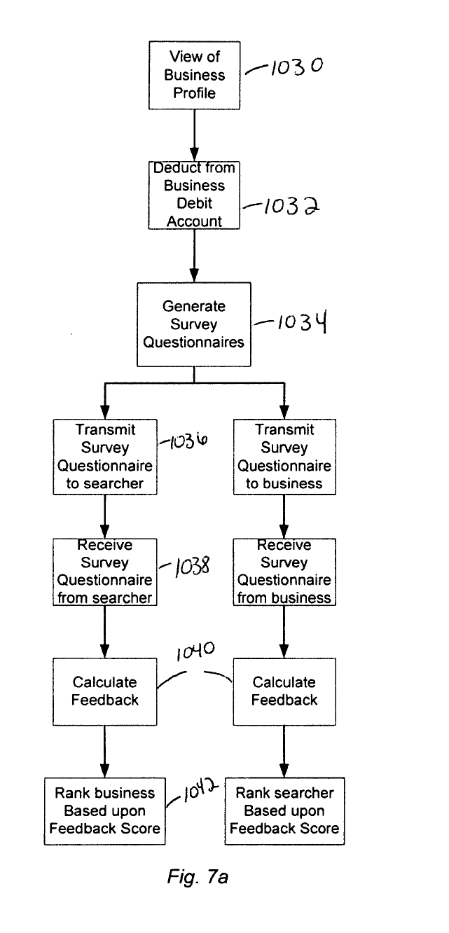

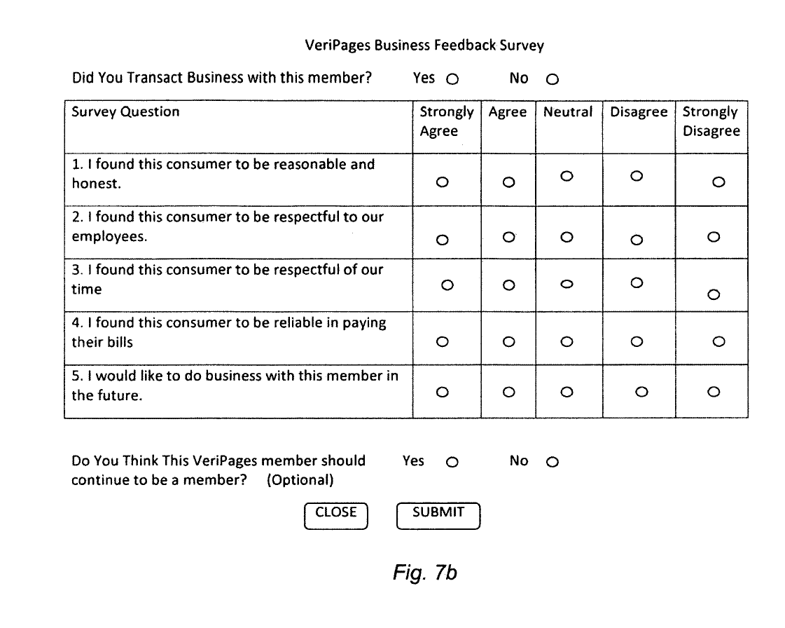

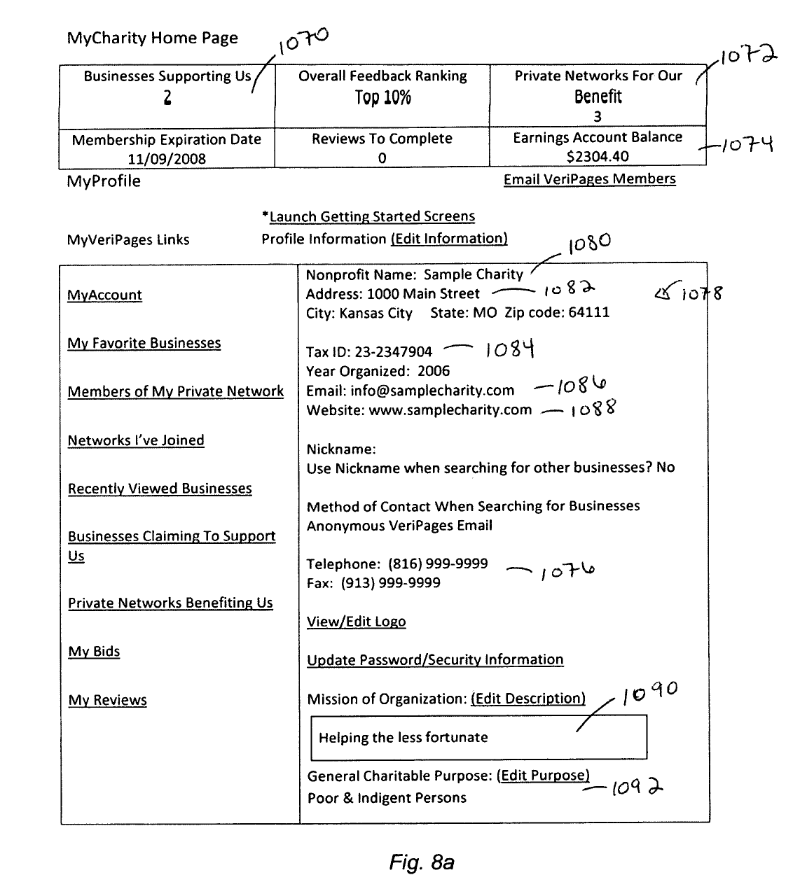

As illustrated in FIG. 7a, a search of the database based upon consumer criteria for a business having business criteria matching the consumer criteria may result in a listing of businesses from which a consumer may select and view the business profile 1030. If the business profile is viewed 1030, the system deducts 1032 an amount from the business debit account setup by the business when it became a registered member. At least partly because the user profile was viewed 1030, the system 10 generates 1034 and submits 1036 the feedback questionnaire to the business and consumer accounts. Once both the business member and consumer member complete the feedback questionnaire, providing relevant feedback associated with the viewing of the profile and any associated consumer transaction, the questionnaire is transmitted back to the system 1038. The business and consumer's feedback score is then calculated 1040 by the system, associating the feedback score with the relevant parties and adjusting the parties rankings accordingly 1042. A sample feedback questionnaire is provided in FIG. 7b, which may generated by the system as a result of various criteria including those selected by the searcher and/or the business.

In addition, to promoting a consumer transaction, if the viewing of the business profile was a result of a referral from the private network, the private network may receive a portion of any proceeds deducted from the business debit account by the system as a result of the review of the business profile. If the searching party who reviewed the business profile receives a non-negative feedback from the business whose profile was reviewed, the searcher may also receive a portion of the proceeds. The proceeds may be in the form of system rewards, credits or perk points and can be credited to the members account.

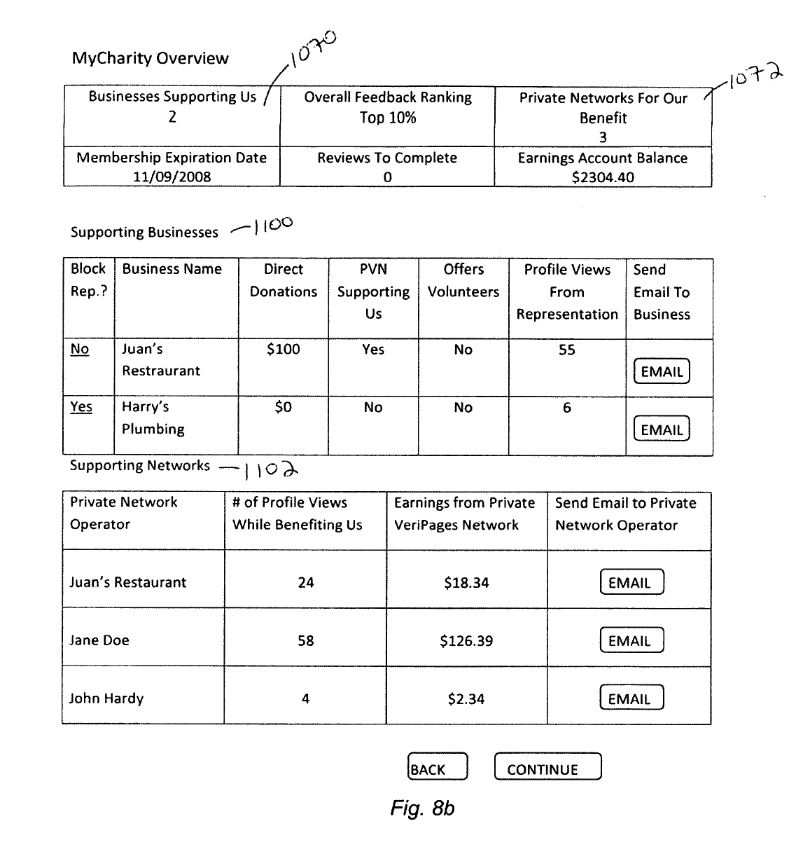

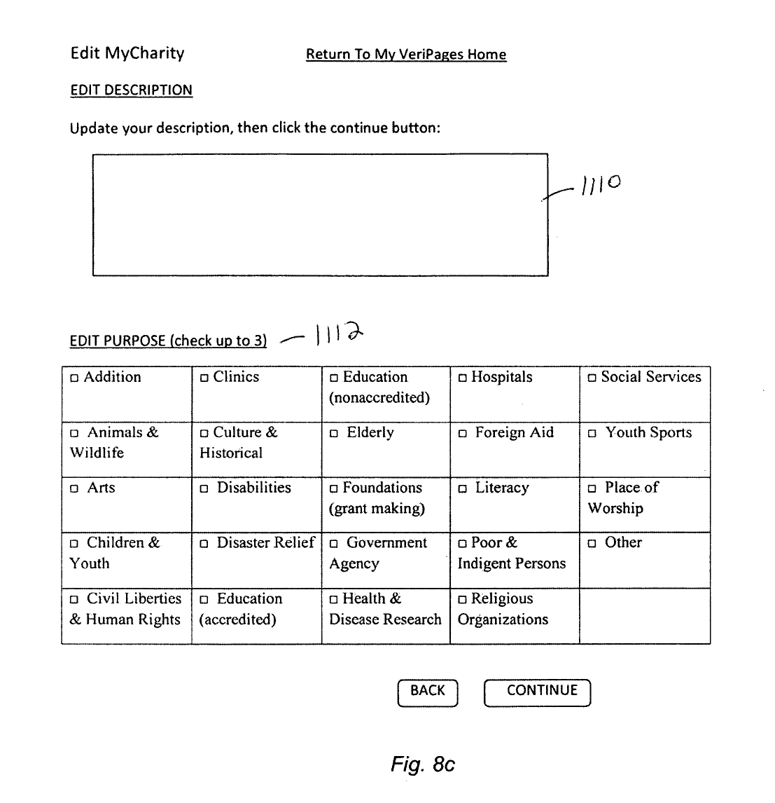

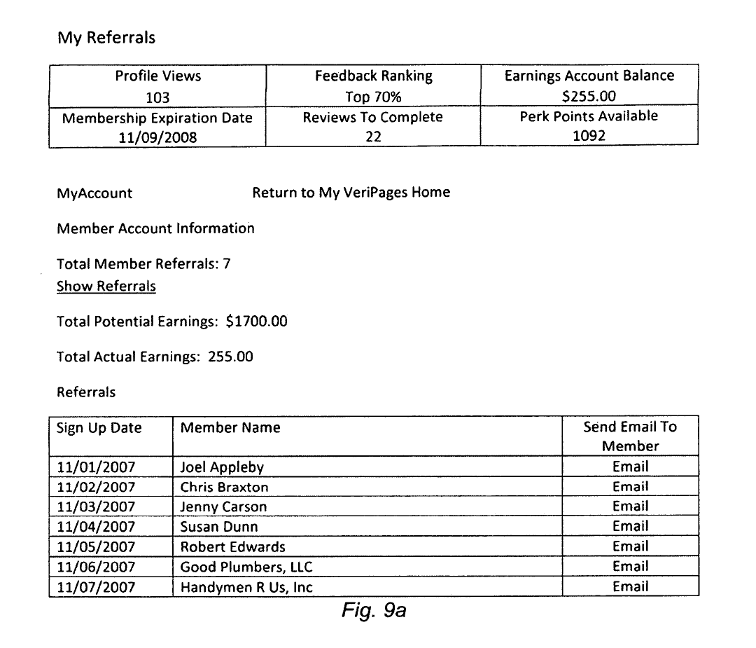

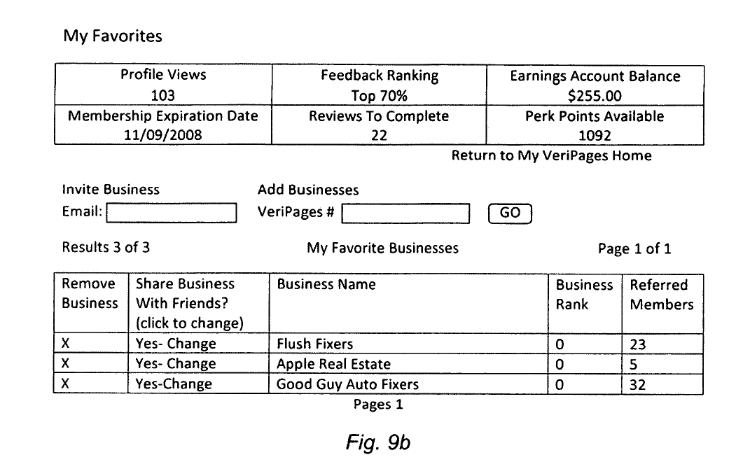

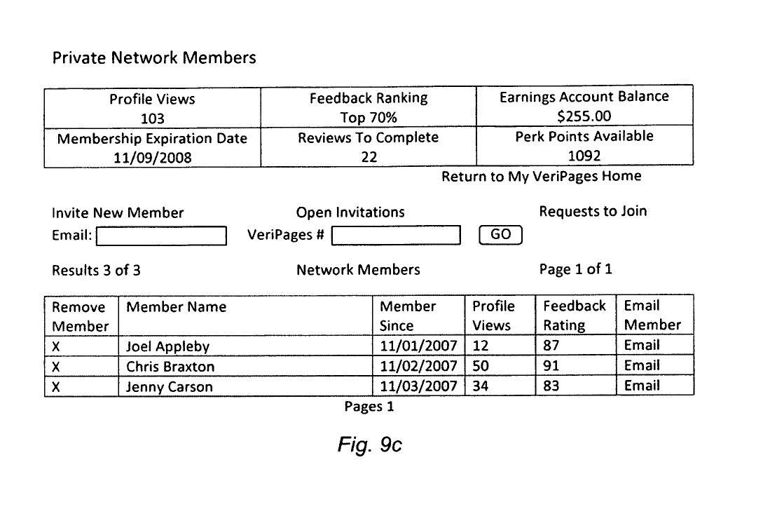

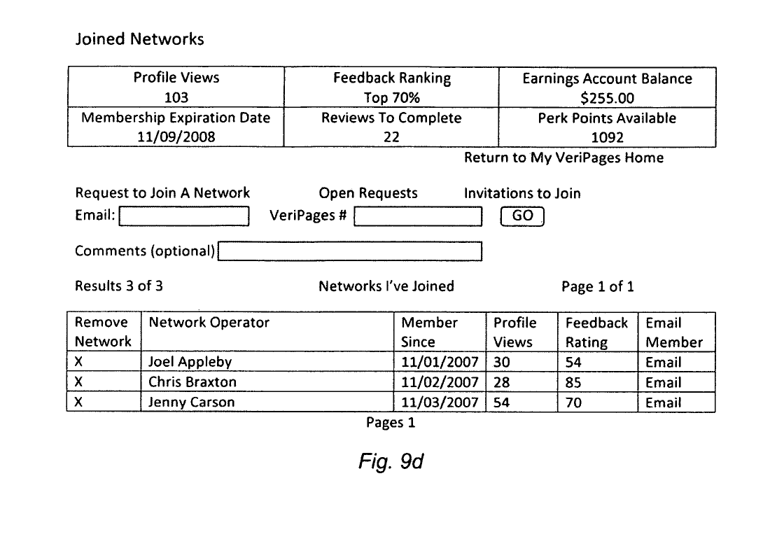

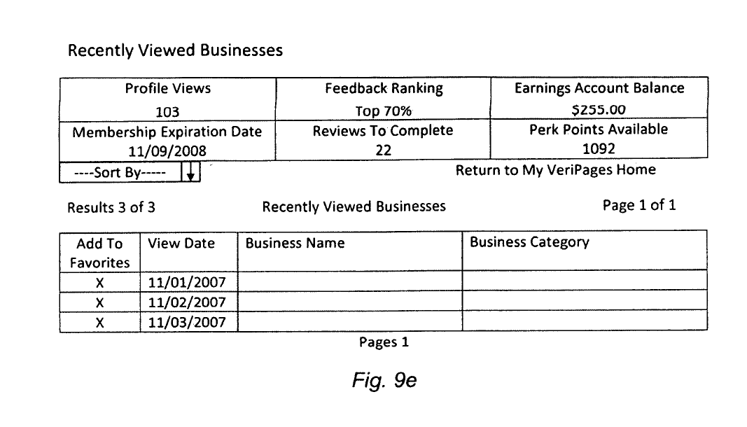

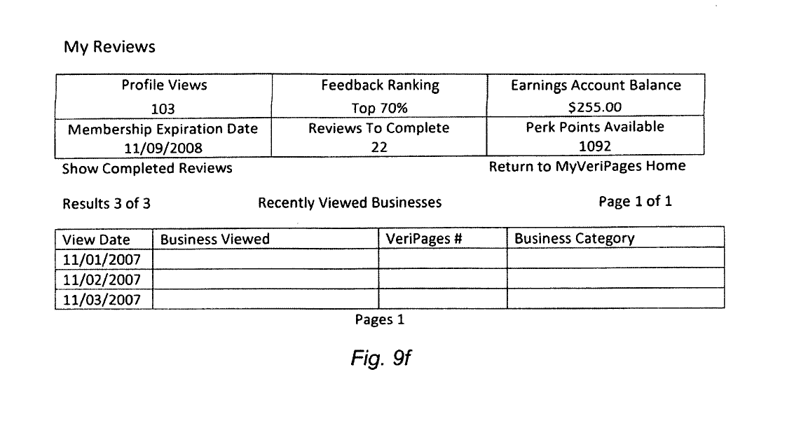

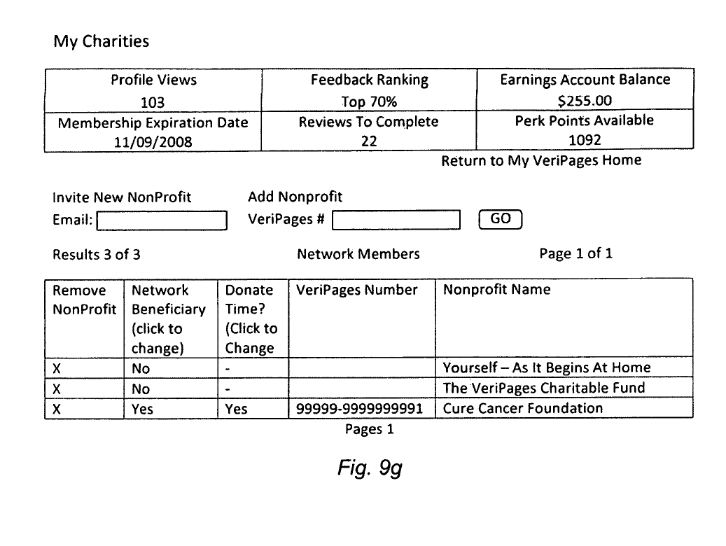

In addition to the Business Home page of FIG. 6a, a charity or other nonprofit member may review, configure, update or edit their Home Page for displaying various system data similar to the Business Home Page with additional information related to providing the charitable member an opportunity to modify any charitable or other data. For illustration purposes only, a Charity Home Page is shown in FIG. 8a along with a Charity Summary screen being illustrated in FIG. 8b. As seen in FIG. 8a, the charity member can view the number of businesses supporting the charity 1070, the number of private networks 1072 which have designated the charity as a beneficiary and an earnings account balance 1074. In addition, various contact information 1078 is illustrated including name 1080, address 1082, tax id 1084, email 1086 and website 1088 along with the charities mission statement 1090 and charitable purposes category 1092. By designating a general purposes category, a searcher can locate the charity member based upon the charitable purpose, without actually knowing the name of the charity. In this way, the system 10 allows for the grouping of multiple charities for searching the charities like a telephone directory, except that the charities can also be searched based upon the designated charitable purpose 1092 rather than based upon the name 1080 or telephone number 1076.

The charity overview screen of FIG. 8b may provide additional details about the Supporting Businesses 1100 or the Supporting Networks 1102 which have designated the charity as a beneficiary. In this way, the charity can evaluate, in real-time, which networks or businesses have benefited the charity and the level of benefit received. This information may be helpful when discussing with the business or network additional ways to give or to assist the charity. The statistical information may also be helpful in considering similarly situated businesses or networks for additional targeted marketing. The information may also help the charity evaluate joining additional private networks or business networks. This feature enables the businesses and charities to assist each other through receiving donations and referrals.

FIG. 8c illustrates the Charity Configuration screen in which the charity may review, edit or update the charity's description 1110 and the charitable purpose 1112.

A user of the present invention may choose any of the above embodiments, or an equivalent thereof, depending upon the desired application. In this regard, it is recognized that various forms of the subject referral system could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

Other aspects, objects and advantages of the present invention can be obtained from a study of the drawings, disclosure and appended claims. However, it is to be understood that while certain forms of this invention have been illustrated and described, it is not limited thereto except insofar as such limitations are included in the following claims and allowable equivalents thereof.

Having thus described the invention, what is claimed as new and desired to be secured by Letters Patent is:

1. A method for providing a consumer with a recommended business provider listing comprising:
receiving consumer user criteria wherein said criteria includes one or more user consumer preferences;
receiving business provider criteria wherein said business provider criteria includes one or more provider preferences; and
providing said consumer user with one or more business provider listings wherein said business provider listing is responsive to said consumer preferences and said consumer User 1s responsive to said provider preferences.

2. The method of claim 1 wherein the step of providing further includes the step of ranking said business provider listing according to a business feedback rank

3. The method of claim 1 further comprising:
associating a business profile with said business provider wherein said business profile includes contact information;
ranking said business provider listings according to one or more consumer preferences;
displaying said business profile by said consumer in response to said business provider listing; and
transferring economic value from a business debit account in response to said display of said business profile.

4. A referral network search system comprising:
an input device;
a database of business listings, each business listing being associated with a respective registered member,
each business listing including a business provider criteria wherein said business provider criteria includes one or more provider preferences;
a variable feedback rank, the feedback rank being determined by the system at least partly in response to a feedback questionnaire;
said search listing being displayable with other search listings in a rank according to the associated feedback rank stored in the database;
a search feature responsive to consumer criteria received at the input device over a computer network from plural consumers for searching the database, the search feature including code to identify search listings retrievably stored within said database matching said consumer criteria received from the consumer, and
an output device to display the search result.

5. The system of claim 4 wherein said search feature further comprises code for searching said database using consumer provided keywords.

6. The system of claim 4 further comprising a variable referral debit said debit being withdrawn from a debit account of the respective business when the search listing including the provider search criteria is referred to a consumer in response to a consumer criteria including one or more consumer preferences is provided by the consumer.

7. The system of claim 4 further comprising a plurality of coded instructions to order the matching search listings in a search result list using the consumer preferences, coded instructions to transmit the search result list to the consumer in response to receipt of the search query from the consumer, and coded instructions to transfer economic value from the respective business, associated with the search listing, when a business profile associated with business provider is displayed by the consumer.

8. The system of claim 4 wherein said feedback questionnaire is generated by the system in response to the display of said business profile on said output device, said input device facilitating the completion of said questionnaire, code to record and evaluate said completed questionnaire and code to adjust said feedback ranking of the business in response to said completed questionnaire from the consumer.
